(19) United States
(12) Patent Application Publication
(10) Pub. No.: US 2026/0288786 A1
(43) Pub. Date: Sep. 24, 2026

(54) SYSTEM

(71) Applicant: SoftBank Group Corp., Tokyo (JP)

(72) Inventor: Kazuhiro NINOMIYA, Tokyo (JP)

(73) Assignee: SoftBank Group Corp., Tokyo (JP)

(21) Appl. No.: 19/564,280

(22) Filed: Mar. 12, 2026

(30) Foreign Application Priority Data
Mar. 19, 2025 (JP) 2025-045039

(51) Int. Cl. G06F 16/3329; G06F 16/34

(52) U.S. Cl. CPC G06F 16/3329; G06F 16/345

(57) ABSTRACT

A system includes a processor that is configured to provide an interface for receiving an analysis instruction from a user, collect free data, paid data, and user-specific data based on the analysis instruction, perform preprocessing on the collected data and generate a prompt for instructing a generative AI model to analyze the data, analyze the data by using the generative AI model to generate insights, interpretations, and strategy planning, generate an analysis result in a text format and generate graphs and numerical information by using data visualization techniques, and provide the generated analysis result to the user.

### CROSS-REFERENCE TO RELATED APPLICATION

This application is based on and claims priority under 35 USC 119 from Japanese Patent Application No. 2025-045039 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional data analysis environments, users are required to manually gather heterogeneous data from multiple sources, including free public data, paid commercial datasets, and proprietary internal data. Such manual collection is time-consuming, prone to omission of relevant information, and often requires technical knowledge of each data source. Furthermore, even when the data is successfully collected, users must perform complex preprocessing tasks such as normalization, cleaning, and integration before meaningful analysis can be conducted. This complexity creates a high barrier to entry for non-expert users and delays decision-making processes.

In addition, conventional analytic tools typically provide limited support for generating high-level business insights, interpretations, and strategic recommendations from the collected data. Many existing systems focus primarily on numerical analysis or static dashboards, and they do not fully exploit recent advances in generative AI models and natural language processing techniques. As a result, users must interpret raw metrics and graphs by themselves and manually derive insights and strategies, which can lead to inconsistent quality and require significant expertise.

Moreover, existing systems often separate textual analysis from visual and numerical representation of results. Users may need to use different tools to obtain narrative reports, graphs, and numerical indicators, which leads to fragmented workflows and additional effort in consolidating outputs. There is therefore a need for a unified system that can, based on user analysis instructions, automatically collect and preprocess diverse data sources, invoke generative AI models to perform advanced analysis, and output both textual insights and complementary graphical and numerical information in an integrated manner.

Accordingly, it is an object of the present invention to provide a system capable of receiving analysis instructions from a user, automatically collecting and preprocessing free data, paid data, and user-specific data, and utilizing a generative AI model and natural language processing techniques to generate integrated analysis results including insights, interpretations, strategy planning, and data visualizations, thereby supporting efficient and informed decision-making by the user.

### SUMMARY

In order to achieve the above-described object, according to one aspect of the present invention, there is provided a system comprising a processor, wherein the processor is configured to provide an interface for receiving an analysis instruction from a user. Based on the received analysis instruction, the processor is configured to collect free data, paid data, and user-specific data from corresponding data sources. The processor is further configured to perform preprocessing on the collected data, including at least one of normalization, cleaning, integration, and summarization, and to generate a prompt for instructing a generative AI model to analyze the data.

The processor is configured to analyze the data by using the generative AI model so as to generate insights, interpretations, and strategy planning. In particular, the processor is configured to cause the generative AI model to apply natural language processing techniques to interpret the data in the context of the analysis instruction. The processor is configured to generate an analysis result in a text format based on an output of the generative AI model, the analysis result including narrative descriptions of trends, causal interpretations, and proposed strategies corresponding to the user's objective and analysis perspective.

Furthermore, the processor is configured to generate graphs and numerical information by using data visualization techniques, the graphs and numerical information being derived from the preprocessed data and optionally from structured outputs of the generative AI model. The processor is configured to associate the generated graphs and numerical indicators with the textual analysis result such that the user can comprehend the insights and strategies with reference to underlying quantitative evidence.

The processor is configured to provide the generated analysis result, including the text format result and the graphs and numerical information, to the user. In one embodiment, the processor is configured to transmit the analysis result to a terminal of the user, thereby enabling the terminal to display the textual insights and render the graphs and numerical information. By these means, the system according to the present invention allows the user to receive, through a single interface, integrated analysis outcomes that combine generative AI-based narrative insights with visual and numerical representations, thereby solving the above-mentioned problems and facilitating data-driven decision-making.

The term “system” refers to an arrangement of one or more hardware components, software components, or a combination thereof, that cooperatively operate to execute the processing defined in the claims.

The term “processor” refers to any hardware device or combination of hardware devices capable of executing instructions, including but not limited to a central processing unit (CPU), a graphics processing unit (GPU), a microcontroller, or a specialized accelerator, and may be implemented as a single physical unit or as a plurality of distributed processing units. The term “interface” refers to a hardware and/or software component that enables input and/or output between the system and a user or external device, including but not limited to graphical user interfaces, command-line interfaces, application programming interfaces (APIs), and communication modules.

The term “analysis instruction” refers to information received from a user that specifies at least one analysis objective, condition, perspective, or constraint to be used by the system for collecting and analyzing data.

The term “user” refers to a person, organization, or external system that provides the analysis instruction to the system and receives an analysis result generated by the system.

The term “free data” refers to data obtainable without individual transaction-based payment, including publicly available datasets, open data provided by public institutions, or data accessible under free licenses.

The term “paid data” refers to data obtainable from commercial providers or subscription-based services that require payment, licensing, or contractual agreements for access and use.

The term “user-specific data” refers to data that is owned, managed, or designated by the user, including proprietary internal data, uploaded files, or data stored in a user's own database or storage system.

The term “preprocessing” refers to one or more operations performed on collected data prior to analysis by a generative AI model, including but not limited to cleaning, normalization, transformation, integration, filtering, aggregation, and summarization.

The term “generative AI model” refers to a machine learning model capable of generating output data such as text, numbers, or structured representations based on input data and instructions, including but not limited to large language models and other generative models.

The term “prompt” refers to information provided to the generative AI model that includes at least one of the analysis instruction, data summaries, and control parameters, and that specifies how the generative AI model is to analyze the collected data.

The term “natural language processing techniques” refers to computational methods and algorithms for processing, understanding, or generating human language, including but not limited to parsing, semantic analysis, sentiment analysis, summarization, and language generation.

The term “insights” refers to analytic conclusions, findings, or observations derived from the collected data and generated by the system, which reveal patterns, trends, relationships, or implications that are not directly evident from raw data.

The term “interpretations” refers to explanatory statements that describe causes, context, or meanings underlying the observed data patterns and insights, including explanations of why certain trends or relationships may occur.

The term “strategy planning” refers to the generation of recommendations, action plans, or proposed measures that a user may adopt in response to the insights and interpretations derived from the data analysis.

The term “analysis result” refers to an output generated by the system that includes at least one of textual content, numerical information, and data visualizations, and that reflects the outcome of analyzing the collected data in accordance with the analysis instruction.

The term “text format” refers to a representation of the analysis result as human-readable character data, including narrative descriptions, bullet lists, summaries, or structured textual reports.

The term “data visualization techniques” refers to methods and tools for converting numerical or categorical data into graphical representations, including but not limited to bar charts, line graphs, pie charts, scatter plots, heat maps, and dashboards.

The term “graphs” refers to visual representations of data produced by the system using data visualization techniques, where variables are arranged along axes or in other visual arrangements to convey quantitative or categorical relationships.

The term “numerical information” refers to quantitative values derived from the collected data or from outputs of the generative AI model, including but not limited to metrics, indicators, statistics, aggregated values, and calculated indices.

The term “terminal” refers to any device or client system used by the user to interact with the system, including but not limited to personal computers, smartphones, tablet devices, and web clients, which can receive and display the analysis result.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

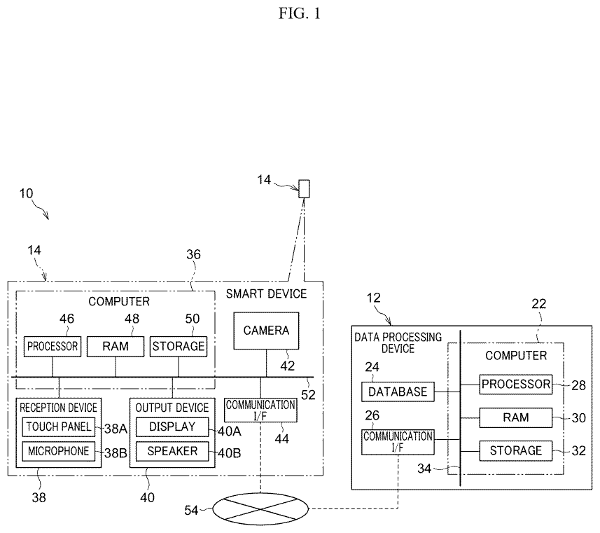

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

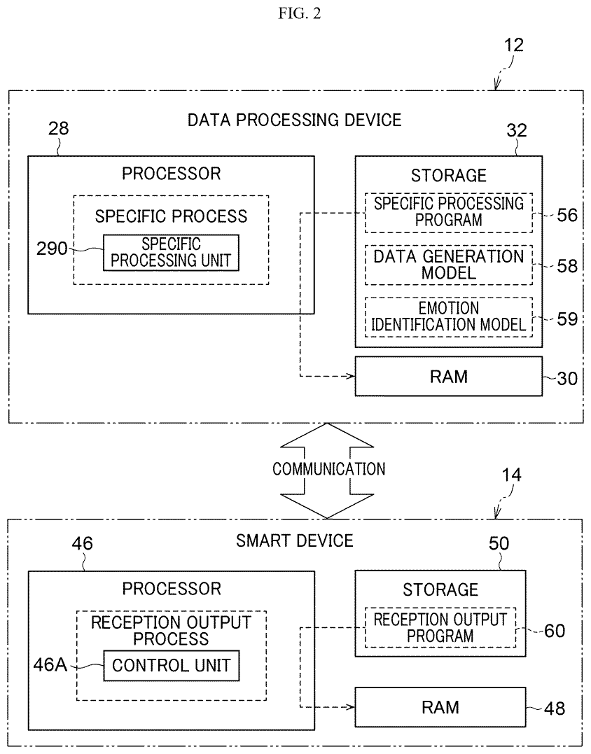

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional data analysis systems that incorporate machine learning or generative models typically treat data collection, data preprocessing, model prompting, model execution, and result presentation as loosely coupled and often manual stages. In many such systems, a user is required to separately gather data from heterogeneous sources, normalize and integrate these data using specialized tools, manually craft a suitable prompt sentence for a generative AI model, and then post-process the model's output to extract actionable insights and visualizations. This fragmented workflow imposes a heavy cognitive and operational burden on the user, requires substantial expertise in data engineering and prompt engineering, and often leads to inconsistent and non-reproducible analysis results.

Furthermore, existing systems do not adequately manage the transformation of large, heterogeneous data sets into compact, machine-consumable representations that respect the input constraints of a generative AI model while preserving analysis fidelity. Naive inclusion of raw data into prompts can exceed context limitations, cause truncation or omission of relevant portions of the data, and degrade the quality and stability of the generated analysis. There is also insufficient support for systematically structuring the model's natural-language output into machine-usable artifacts such as key performance indicators, recommended actions, and evaluation metrics that can be programmatically visualized and reused in subsequent analyses.

Additionally, many systems lack an integrated mechanism for iterative and continuous analysis, in which new prompt sentences from the user can be interpreted in light of stored prior results and prior prompts. Without a formal history management and prompt-update mechanism, each interaction with the generative AI model is effectively stateless, forcing the user to repeatedly restate context, reselect data, and manually reconcile current results with past insights. This leads to inefficiency, duplication of processing, inconsistent decision support, and increased resource consumption.

Accordingly, there is a need for a computer-implemented system and method that improves the technical functioning of data analysis infrastructure by: (i) automatically acquiring and integrating multiple categories of data from heterogeneous information sources; (ii) generating structured, context-constrained data summaries as inputs to a generative AI model; (iii) automatically constructing and updating analysis prompts in response to user instructions and stored history; (iv) programmatically structuring and visualizing the model's natural-language output; and (v) enabling iterative, context-aware analysis sessions. Such improvements should reduce manual intervention, improve computational efficiency and reproducibility, and provide more consistent and actionable decision-support information to the user.

The specific processing by the specific processing unit 290 of the data processing device 12 in Example 1 is realized by the following means.

The present invention provides a server comprising a processor configured to provide an input/output interface for receiving, from a user, an analysis instruction including an analysis purpose, a data range, and a prompt sentence; to acquire, based on the analysis instruction and via a communication function and a storage function, a plurality of types of data including public information obtained from a plurality of external information sources, paid information provided on a contractual basis, and individual information provided by the user; to perform preprocessing on the acquired plurality of types of data by unifying data formats, processing missing values, converting units, aligning time series, and joining the data based on identification attributes to generate an integrated data set; to calculate, from the integrated data set, predetermined indicators, statistical values, aggregated results, and representative samples, and to summarize the calculated results in a text format or a table format so as to generate data summary information corresponding to an input constraint of a generative AI model; to construct an analysis prompt including the prompt sentence from the user, analysis conditions, the data summary information, and an instruction regarding an output format required from the generative AI model, and to generate the analysis prompt as input data for the generative AI model; to transmit the analysis prompt to the generative AI model, receive an analysis result text in natural language from the generative AI model, and generate structured information by extracting summary information, key indicators, recommended actions, and evaluation metrics from the analysis result text; to generate, based on the structured information, at least one piece of graphical information or table-format information that visualizes the analysis result by using a visualization library to represent at least one of temporal changes, category-wise comparisons, and ratio distributions; to generate report information including the analysis result text, the structured information, and the visualized graphical information, and to transmit the report information to a user terminal via the communication function; and to store the report information in a form usable for decision-making by the user, and to perform history management by making stored information referable and reusable for iterative analysis processing based on an additional prompt sentence. This enables an integrated and technically improved data analysis workflow in which heterogeneous data sources are automatically normalized and summarized into model-ready representations, generative AI model interaction is systematically orchestrated through dynamically constructed prompts, model outputs are converted into structured and visualized decision-support artifacts, and iterative, context-aware analyses are efficiently executed with reduced user burden and enhanced computational consistency.

The term “processor” refers to a hardware or virtual computation unit, such as a central processing unit or an execution core in a computing environment, configured to execute machine-readable instructions to perform the functions described herein.

The term “input/output interface” refers to a hardware and/or software component configured to receive information from a user or an external system and to present information to the user or the external system, including but not limited to graphical user interfaces, application programming interfaces, and network interfaces.

The term “analysis instruction” refers to information received from a user that specifies at least an analysis purpose and a data range, and may further include constraints, parameters, and a prompt sentence for controlling data acquisition and analysis processing.

The term “prompt sentence” refers to a natural-language or structured input expression provided by a user, or constructed by the system, for directing a generative AI model to perform a specified analysis, explanation, or reasoning task.

The term “public information” refers to data made available without individual contractual arrangements, including data accessible via open interfaces, public databases, or publicly distributed files.

The term “paid information” refers to data provided under a contractual or subscription arrangement, typically subject to usage limitations or access control, and obtained from external information providers through authenticated communication.

The term “individual information” refers to data that is provided or uploaded by a user or is otherwise associated with a specific user, including proprietary business data, transaction records, or other user-specific datasets.

The term “communication function” refers to a hardware and/or software mechanism enabling the exchange of data between the server and external systems or terminals over one or more communication networks.

The term “storage function” refers to a hardware and/or software mechanism, such as volatile or non-volatile memory and associated control logic, configured to store, retrieve, and manage data used or generated by the system.

The term “preprocessing” refers to a sequence of operations applied to raw data, including format conversion, normalization, error checking, and data cleaning, in order to prepare the data for subsequent analysis.

The term “integrated data set” refers to a collection of data obtained by combining multiple data sources into a unified structure in which data formats, units, identifiers, and temporal references have been harmonized.

The term “identification attributes” refers to one or more fields or keys, such as time, category, region, or entity identifiers, used to align and join data records originating from different sources.

The term “predetermined indicators” refers to quantitative measures derived from the integrated data set, such as totals, averages, growth rates, or other metrics defined in advance based on the analysis requirements.

The term “statistical values” refers to numerical values derived from statistical computations on the integrated data set, including but not limited to means, medians, variances, standard deviations, and correlation coefficients.

The term “aggregated results” refers to data values obtained by grouping and summarizing records according to one or more dimensions, such as time periods, categories, or regions, using operations such as summation, counting, or averaging.

The term “representative samples” refers to selected subsets or example records from the integrated data set that are chosen to illustrate typical patterns, distributions, or notable cases relevant to the analysis.

The term “data summary information” refers to a condensed representation of the integrated data set, including indicators, statistical values, aggregated results, and representative samples, expressed in text or table format for use within an input constraint of a generative AI model.

The term “input constraint of a generative AI model” refers to a limitation associated with the generative AI model regarding the size, length, format, or structure of input data that can be processed by the model in a single operation.

The term “analysis prompt” refers to a structured input for a generative AI model that includes at least a prompt sentence, analysis conditions, data summary information, and instructions specifying an expected output format or content.

The term “generative AI model” refers to a machine-learning model, typically based on neural-network architectures, configured to generate natural-language or structured outputs in response to given prompts or input data.

The term “analysis result text” refers to natural-language output generated by the generative AI model in response to an analysis prompt, including explanatory descriptions, interpretations, and recommendations.

The term “structured information” refers to information derived from the analysis result text that has been organized into machine-readable formats, such as lists, key-value pairs, tables, or records, suitable for subsequent processing or visualization.

The term “summary information” refers to portions of the analysis result text or derived data that concisely describe main findings, key observations, or overall trends identified by the analysis.

The term “key indicators” refers to selected quantitative or qualitative metrics extracted from the analysis result text or the integrated data set that are particularly relevant for evaluating performance or conditions in the analysis context.

The term “recommended actions” refers to proposed operations, strategies, or decisions suggested by the system based on the analysis result text and structured information. The term “evaluation metrics” refers to measures or criteria used to assess the effectiveness, risk, or expected outcome of recommended actions or observed conditions, and may include quantitative thresholds, scores, or qualitative ratings.

The term “graphical information” refers to information represented in a visual form, such as charts, graphs, plots, or diagrams, generated from structured information to assist user understanding of analysis results.

The term “table-format information” refers to information arranged in rows and columns, such as data tables, matrices, or lists, that present structured information in a tabular layout.

The term “visualization library” refers to a software component or collection of functions configured to generate graphical or tabular representations of data, such as charts or plots, from structured information.

The term “temporal changes” refers to variations in data values observed over time, including trends, seasonality, or abrupt shifts identified by comparing data points across temporal intervals.

The term “category-wise comparisons” refers to comparisons of data values or metrics across discrete groups or categories, such as product types, regions, or customer segments.

The term “ratio distributions” refers to patterns or distributions of relative quantities, such as percentages, proportions, or shares, computed from data elements and analyzed across categories or time.

The term “report information” refers to a collection of data including at least the analysis result text, structured information, and graphical or table-format information, organized for presentation to a user as a coherent analysis output.

The term “user terminal” refers to an electronic device operated by a user, such as a computing device with a display and communication capability, configured to send instructions to and receive results from the server.

The term “history management” refers to processes for storing, indexing, and retrieving past analysis-related data, including prompts, integrated data summaries, analysis result texts, structured information, and report information, for subsequent reuse.

The term “iterative analysis processing” refers to a sequence of related analysis operations in which later analyses are performed with reference to data or results obtained in one or more previous analyses, often driven by additional prompt sentences from the user.

The term “analysis conditions” refers to parameters, constraints, or settings that define the scope and manner of an analysis, such as target periods, regions, categories, and desired level of detail.

The term “executable strategy plan” refers to a set of recommended actions and associated conditions, structured so that a user can practically implement the actions in an operational or business environment.

The term “past analysis prompts” refers to analysis prompts that have been previously constructed and used in interactions with the generative AI model, and that are stored by the system for later reference.

The term “new prompt sentence” refers to a prompt sentence provided by the user after one or more prior analyses have been conducted, which is intended to refine, extend, or modify the analysis context.

The term “stepwise manner” refers to a procedure in which an analysis prompt or configuration is updated through multiple successive modifications, each incorporating additional information or constraints, rather than by a single replacement operation.

The term “iterative and continuous analysis results” refers to a series of analysis outputs generated over time, each related to and building upon prior results, thereby providing a continuous evolution of insights as additional inputs are received from the user.

The server is implemented as one or more physical or virtual machines comprising at least one central processing unit, a main memory, a non-volatile storage device, a network interface, and a display or console for administration. The server executes an operating system such as a general-purpose server operating system and an application stack including a web server, an application framework, a database management system, and a model-inference component. The server communicates with at least one terminal over a packet-based network using standardized protocols.

The terminal is implemented as an information processing device such as a personal computer, a tablet device, or a smartphone. The terminal includes a central processing unit, a memory, a display, an input device, and a communication interface. The terminal executes a client program such as a web browser or a native application providing a graphical user interface for the user. The terminal transmits analysis instructions and prompt sentences to the server and receives and displays report information including analysis result text, structured information, and graphical information.

The user operates the terminal to specify an analysis purpose and a data range and to input a prompt sentence in natural language. For example, the user can input the following prompt sentence:

“Please analyze the market trends in 2023 for the consumer electronics industry in North America and propose a concrete sales strategy for 2024.”

The server receives this prompt sentence together with parameters such as target period, region, industry classification, and desired output sections. The server stores these parameters as structured records in a relational database management system such as a general-purpose relational database, using tables for user accounts, analysis jobs, data sources, and result artifacts. The server uses structured query language to manage these records and to relate a particular analysis job to specific input conditions and output artifacts.

The server acquires multiple categories of data from heterogeneous sources. The server uses an HTTP client library to call public data interfaces exposed by external data services, for example open statistical interfaces and public data repositories. The server retrieves paid information through authenticated interfaces provided by contracted data services, using an authentication token or key stored in a secure storage component. The server acquires individual information by loading files that the user has previously uploaded to an object storage service or by executing database queries against a user-specific schema. The server converts each external response, which may be in formats such as structured text, comma-separated values, or hierarchical data notation, into internal data structures such as typed columns in in-memory tables.

The server performs data processing and data calculation using a data-analysis software library such as a table-oriented computation library or a distributed data-processing framework. The server normalizes field names, converts textual date fields into a standardized date-time representation, converts numerical units into a consistent base unit, and maps categorical labels to standardized codes. The server uses identification attributes such as time stamps, geographic segments, product categories, and entity identifiers to align records from different sources, joining data tables based on these attributes to form an integrated data set. The server also detects and handles missing values using deterministic rules, such as discarding records with missing key identifiers, imputing time-series values using interpolation, or replacing missing categories with an explicit “unknown” label.

The server calculates predetermined indicators and statistical values from the integrated data set. The server computes metrics such as totals, averages, medians, growth rates, moving averages, and correlations across dimensions specified by the analysis conditions. The server aggregates values by time unit, category, or region using grouping operations and aggregation functions. The server selects representative samples by applying stratified sampling or ranking records by significance measures such as magnitude of change, deviation from the mean, or contribution to a particular metric. The server formats these computed values as compact text tables or summary bullet lists, thereby generating data summary information.

The server uses the data summary information to construct an analysis prompt for a generative AI model. The server implements a prompt-construction module that takes as input the user's original prompt sentence, analysis conditions, and the computed data summary. The module uses a template mechanism to generate a composite text that includes: (i) a role description directing the model to behave as a domain-specific analyst; (ii) an explicit restatement of the analysis objective; (iii) the data summary information expressed in machine-readable textual structures such as table-like sections or enumerated lists; and (iv) instructions specifying the expected sections and granularity of the output, including requirements to output both qualitative explanations and quantitative targets.

The server employs a generative AI model implemented as a trained neural network. In one embodiment, the generative AI model is a transformer-based sequence model comprising a stack of self-attention layers, feed-forward layers, and normalization layers. The model parameters consist of weight matrices and bias vectors stored as floating-point values, for example using 16-bit or 32-bit representations, in the server's memory. The model has been trained on large corpora of text and structured data using an autoregressive objective that minimizes a loss function such as cross-entropy between predicted tokens and ground-truth tokens. During training, the model parameters are updated using an optimization algorithm such as stochastic gradient descent or a variant with adaptive learning-rate adjustments. The model input is a sequence of token identifiers obtained by applying a tokenizer to the prompt text, and the model output is a sequence of token probabilities from which the server selects tokens using decoding strategies such as greedy decoding, beam search, or sampling with temperature control.

The server configures the generative AI model for analysis by setting model parameters such as context length, attention window, and decoding temperature in a manner that balances determinism with variability. The server applies attention masking to ensure that the model attends to both the user's prompt sentence and the data summary information while respecting the order of tokens. The server restricts the prompt size by enforcing a maximum token count and selectively including only those summary segments that are deemed most relevant based on relevance scores computed from correlation measures or prior model outputs. This constrained inclusion of summarized data improves memory usage and inference time, and reduces truncation errors that can occur when an overly long prompt exceeds the model's context window.

The server transmits the constructed analysis prompt to the generative AI model either by invoking a local inference engine running on an accelerator device, such as a graphics-processing unit, or by calling a remote inference service over a network interface. In either case, the server monitors processing time and resource consumption, and logs these metrics to support system optimization. The generative AI model processes the token sequence through its network layers, computing attention distributions and intermediate hidden representations. The model generates an analysis result text in natural language that includes explanatory paragraphs, enumerated insights, and recommended actions.

The server does not treat the analysis result text as a mere human-readable string. Instead, the server uses a dedicated parsing and structuring module to convert the analysis result text into structured information. In one implementation, the server uses rule-based pattern recognition and regular expressions based on predefined markers and section labels that were required in the prompt. In another implementation, the server uses a secondary lightweight model configured to output a structured notation describing key indicators, recommended actions, and evaluation metrics. The server extracts numerical values, category identifiers, time references, and relational statements, and stores them in structured data objects associated with the analysis job. This composition of rule-based parsing and model-based extraction differs from manual reading by a human, and allows the server to systematically transform narrative output into machine-usable elements.

The server generates graphical information from the structured information using a visualization library executed on the server. The server constructs data series for time-based plots, category comparison charts, and distribution graphs. The server configures chart properties such as axis scaling, legend grouping, and color coding. The server renders charts as raster images or vector graphics stored in non-volatile storage, and also generates machine-readable chart specifications that can be interpreted by client-side visualization libraries. The server creates table-format information by arranging indicators, metrics, and segment-level results in tabular form with explicit headers and aligned numeric columns.

The server combines the analysis result text, the structured information, and the graphical and tabular information into report information. The server may generate the report as a markup document that can be directly rendered by the terminal's web browser, or as a structured report object that the terminal's client application converts into a user interface. The server stores each report together with metadata such as creation time, input conditions, and references to underlying data sets. The server uses these stored reports as a history database.

The server provides a history management mechanism for iterative analysis. When the user subsequently issues a new prompt sentence, such as:

“Based on the previous analysis, please refine the 2024 strategy specifically for online channels and propose monthly budget allocation.”

The server retrieves related past analysis prompts, structured information, and report information from the storage. The server interprets the new prompt sentence in the context of these past results by identifying references such as “previous analysis” or specific segments.

The server then constructs a new analysis prompt that explicitly incorporates the relevant past outputs as summarized context, without requiring the user to restate all prior details. This stepwise prompt update allows the system to perform iterative and continuous analyses while controlling memory usage and avoiding repeated data acquisition and preprocessing.

The server's architecture and algorithms improve computer technology beyond mere automation of human reasoning. By using integrated data structures and standardized identifiers, the server reduces data redundancy and enhances cache locality in memory operations, which leads to improved processing speed for data joins and aggregations. The server's generation of compact data summary information reduces the volume of data that must be transferred to and processed by the generative AI model, thereby decreasing communication load and inference latency. The stepwise prompt-update mechanism avoids reprocessing large historical data, leading to lower computational cost for each new analysis iteration.

Additionally, the server's method of structuring the model output introduces deterministic constraints on output format and explicit extraction rules. This reduces variability in interpretive errors, increases the precision of extracted indicators, and enables the use of automatic consistency checks. For example, the server can verify that recommended growth targets are numerically compatible with observed historical data, detect inconsistencies, and, if necessary, regenerate or refine the analysis prompt to correct such inconsistencies, which a human reader could not systematically ensure at scale.

From the perspective of model internals, the server can be configured to fine-tune the generative AI model on domain-specific corpora including past reports and structured indicators, using supervised learning where the target outputs include both narrative sections and their structured counterparts. During such training or fine-tuning, the server computes loss functions that penalize both deviations in generated text and deviations in extracted structured fields. The server updates the model's weights using gradient-based optimization, and may apply techniques such as learning-rate scheduling, regularization, or data augmentation (e.g., paraphrasing of prompt sentences, shuffling of non-critical sections) to improve generalization. This tailored training procedure improves the accuracy and stability of the model in transforming summarized data into consistent narrative and structured outputs, thus improving the technical performance of the system.

The server can employ alternative generative AI architectures, such as encoder-decoder models or sparse-attention transformers, provided that they support token-sequence input and output. The server may implement different tokenization schemes, such as subword units or byte-level encoding, and can adjust the maximum context window and model depth according to hardware capabilities. The server can distribute model inference across multiple processor cores or accelerator devices, using load-balancing strategies to allocate analysis jobs based on resource availability. These variations enable the system to scale to large numbers of concurrent users while preserving response times.

The terminal is not a passive display device but participates in the technical solution. The terminal can perform client-side caching of static visualization libraries and style resources, thereby reducing network traffic and rendering latency. The terminal can also offload simple computations such as unit conversions or filtering of result tables, based on structured information provided by the server. This division of labor between server and terminal further contributes to overall system efficiency.

The user interacts with the system through interfaces that guide them toward providing information in forms readily consumable by the server. For example, the interface may use dynamic prompts, auto-completion, and validation rules to help the user specify clear time ranges, categories, and objectives. This user-guidance mechanism reduces erroneous or ambiguous instructions, which in turn improves downstream analysis quality and reduces the need for repeated model invocations.

In alternative embodiments, the server can be deployed in a cloud environment where multiple logical servers share a distributed storage back end, or in an on-premises environment where the generative AI model is executed entirely within a local data center for compliance reasons. The server may integrate with specialized accelerators, such as tensor processing units, to further speed up matrix multiplications and attention computations inside the neural network. The data structures used for integrated data sets may be columnar in-memory representations to optimize analytic queries, or may be row-based structures depending on anticipated access patterns.

By combining specific data structures, algorithmic processing steps, and hardware-aware configurations, the server, terminal, and user cooperate in a system that transforms heterogeneous real-world data into compact model-ready representations, orchestrates generative AI model interactions in a technically optimized manner, and produces structured, visual, and iteratively refined analysis outputs. This cooperation yields concrete technical effects such as improved processing speed, reduced memory usage, enhanced reliability of extracted metrics, and lower network load, thus constituting an improvement to computer technology itself rather than a mere automation of human analytical tasks.

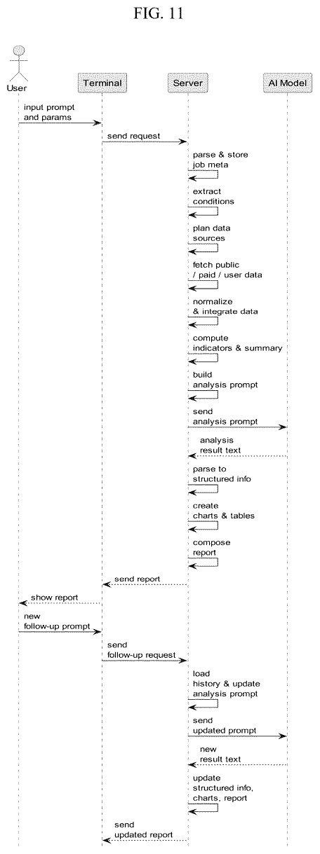

The following describes the processing flow using FIG. 11.

### Step 1:

The user operates the terminal to open a client application and input an analysis instruction.

Input: The user provides an analysis purpose, a data range, and a prompt sentence in natural language (for example, “Please analyze the market trends in 2023 for the consumer electronics industry in North America and propose a concrete sales strategy for 2024.”).

Processing: The terminal validates basic input formats (such as required fields and date formats) and encodes the instruction and prompt sentence into a structured message.

Output: The terminal transmits the structured message, including the prompt sentence and parameters, to the server over a network connection.

### Step 2:

The server receives the analysis instruction from the terminal and stores job metadata.

Input: The server receives a network request that contains the user identifier, the analysis purpose, the data range, and the prompt sentence.

Processing: The server parses the request payload, assigns a unique job identifier, and stores the job metadata in a database table for analysis jobs, including fields for user ID, timestamps, and requested parameters.

Output: The server generates a stored job record and an internal representation of the analysis request.

### Step 3:

The server extracts key entities and analysis conditions from the prompt sentence and parameters.

Input: The server uses the internal representation of the prompt sentence and the explicit parameters received from the terminal.

Processing: The server applies a natural-language analysis module to detect entities such as time periods, industries, regions, and analysis objectives; the server then maps these entities to standardized codes and time ranges, and merges them with explicitly provided parameters.

Output: The server generates a normalized analysis-condition object containing standardized time ranges, category identifiers, region codes, and analysis goals.

### Step 4:

The server determines which data sources are required based on the normalized analysis conditions.

Input: The server uses the normalized analysis-condition object and a configuration of available data sources.

Processing: The server compares requested industries and regions with a catalog of data sources that describes coverage and schemas; the server selects appropriate public data interfaces, paid data interfaces, and user-specific data repositories applicable to the request.

Output: The server produces a data-acquisition plan that lists selected sources, query parameters, and expected output formats.

### Step 5:

The server acquires public (free) data from external information sources.

Input: The server uses the data-acquisition plan entries corresponding to public information and the network communication function.

Processing: The server issues network requests to external public interfaces with query parameters such as time range, region, and category; the server receives responses in formats such as structured text or tabular data and converts each response into in-memory tables by mapping external field names to internal schema fields.

Output: The server generates one or more internal tables representing public information relevant to the requested analysis.

### Step 6:

The server acquires paid data from contracted information sources.

Input: The server uses the data-acquisition plan entries corresponding to paid information and authentication credentials stored in secure storage.

Processing: The server attaches authentication tokens to network requests, sends queries specifying industries, segments, and time ranges, receives structured responses, and parses them into internal tables with standardized field types and units.

Output: The server generates one or more internal tables representing paid information to be combined with other data.

### Step 7:

The server acquires individual information associated with the user.

Input: The server uses the data-acquisition plan entries corresponding to individual information and stored references to user-specific data sets.

Processing: The server retrieves user-uploaded files from storage or queries user-specific database schemas; the server parses these files or query results, infers column types, and maps user-defined fields to standardized internal fields such as date, category, region, and measurement values.

Output: The server generates one or more internal tables representing individual information for the user.

### Step 8:

The server performs preprocessing and normalization across all acquired data tables.

Input: The server uses the internal tables representing public information, paid information, and individual information.

Processing: The server unifies data formats by converting date strings to a standard date-time type, converting units into a consistent base unit, mapping category labels to reference codes, and normalizing numeric scales; the server processes missing values using rules such as interpolation for time-series gaps and marking or removal for incomplete keys.

Output: The server produces normalized tables that share consistent field types, units, and identifiers across all data categories.

### Step 9:

The server integrates the normalized tables into a single integrated data set.

Input: The server uses the normalized tables that share common identification attributes such as time, region, and category codes.

Processing: The server performs join operations on matching identification attributes, aligning records across the various sources; the server resolves conflicts by applying priority rules, such as preferring individual information over public information for overlapping metrics.

Output: The server generates an integrated data set that merges public information, paid information, and individual information into a unified structure.

### Step 10:

The server derives indicators, statistical values, and aggregated results from the integrated data set.

Input: The server uses the integrated data set and the normalized analysis conditions that specify relevant metrics and grouping dimensions.

Processing: The server computes totals, averages, growth rates, ratios, and correlation measures; the server aggregates data by time intervals, categories, and regions, and calculates derived measures such as year-over-year changes and market share differences.

Output: The server generates computed-indicator tables and aggregated-result tables that summarize the integrated data set.

### Step 11:

The server selects representative samples and constructs data summary information.

Input: The server uses the computed-indicator tables, aggregated-result tables, and the integrated data set.

Processing: The server applies selection rules that rank records by significance indicators such as magnitude of change or deviation from baseline; the server chooses representative rows and converts them into text-based summaries and compact tabular segments that highlight key patterns; the server ensures that the combined length of these summaries remains within a predefined limit.

Output: The server generates data summary information containing indicators, aggregates, and representative samples in text or table-like formats.

### Step 12:

The server constructs an analysis prompt for the generative AI model.

Input: The server uses the original prompt sentence, the normalized analysis conditions, and the data summary information.

Processing: The server applies a prompt-template mechanism to assemble a multi-part text that includes role instructions for the model, a restatement of the analysis purpose, the data summary information formatted as lists or tables, and explicit instructions for the structure and detail level of the expected output; the server converts this text into a single coherent analysis prompt.

Output: The server generates an analysis prompt string suitable for tokenization and input to the generative AI model.

### Step 13:

The server invokes the generative AI model with the constructed analysis prompt.

Input: The server uses the analysis prompt string and model-configuration parameters such as context length and decoding settings.

Processing: The server tokenizes the analysis prompt, sends the token sequence to a generative AI model implemented as a neural network, and initiates inference; the server receives a sequence of output tokens that are decoded into natural-language text covering insights, trends, and strategy recommendations.

Output: The server obtains the analysis result text produced by the generative AI model.

### Step 14:

The server converts the analysis result text into structured information.

Input: The server uses the analysis result text and predefined rules or secondary model configurations that describe desired structures such as lists of indicators and actions.

Processing: The server identifies section markers and patterns within the text, extracts numerical values, category labels, and temporal references, and assigns them to predefined data fields; optionally, the server uses an auxiliary extraction model to transform free-form segments into structured records.

Output: The server generates structured information objects that represent summary information, key indicators, recommended actions, and evaluation metrics in machine-readable form.

### Step 15:

The server generates visual and tabular representations of the structured information.

Input: The server uses the structured information objects that include indicators, segment-level values, and time-series metrics.

Processing: The server organizes data into series and categories suitable for graphs, invokes a visualization library to render charts showing temporal changes, category-wise comparisons, and ratio distributions, and composes tables listing core metrics; the server configures visual attributes such as axis labels and color schemes.

Output: The server produces graphical information such as charts and table-format information that together visualize the analysis results.

### Step 16:

The server composes report information and sends it to the terminal.

Input: The server uses the analysis result text, the structured information, and the generated graphical and tabular representations.

Processing: The server assembles these elements into a report object that includes narrative sections, structured lists, and references to visual assets; the server serializes this report object into a response format suitable for the client application.

Output: The server transmits the report information to the terminal, enabling display of the analysis results to the user.

### Step 17:

The terminal presents the received report information to the user.

Input: The terminal receives the report information, including text sections, structured lists, and graphical elements, from the server.

Processing: The terminal parses the report object, renders the analysis result text within a user interface, draws charts using a client-side visualization component or by displaying images, and arranges tables and controls such as filters and navigation widgets.

Output: The terminal displays a complete analysis view that the user can read and interact with.

### Step 18:

The user reviews the analysis output and optionally issues a follow-up prompt sentence.

Input: The user inspects the text, tables, and charts shown on the terminal and considers additional analysis needs.

Processing: The user decides on further questions or refinements and types a new prompt sentence, such as “Based on the previous analysis, please refine the 2024 strategy specifically for online channels and propose monthly budget allocation.”; the terminal packages this new prompt sentence with context identifiers and sends it to the server.

Output: The user provides an additional prompt sentence that the terminal transmits as a new or extended analysis instruction.

### Step 19:

The server performs context-aware iterative analysis based on history.

Input: The server receives the new prompt sentence along with a reference to the existing job identifier and stored report information.

Processing: The server retrieves relevant past structured information and analysis prompts, interprets the new prompt sentence in light of these past results, and constructs a revised analysis prompt that incorporates selected past findings as summarized context; the server then repeats model invocation and result processing using this updated prompt.

Output: The server generates updated analysis results, reflecting iterative and continuous analysis, that can be delivered to the terminal as a refined report.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional data analysis systems for electronic commerce rely on rigid, pre-defined analytical pipelines that require manual configuration of data sources, schemas, and visualization settings. When a user expresses an analysis need in natural language, such systems typically cannot directly interpret the request, automatically acquire heterogeneous data from multiple sources, and generate coherent, strategy-oriented outputs. Instead, engineering personnel must translate business questions into queries, scripts, and dashboard configurations, which increases latency, cost, and error rates.

Furthermore, existing systems generally treat natural language interfaces, data integration, machine learning analysis, and visualization as separate components, without a unified, machine-interpretable “analysis context.” As a result, adding or modifying data sources, changing the analysis scope, or iteratively refining strategic scenarios in response to follow-up user instructions often requires re-executing large portions of the pipeline or rebuilding dashboards, leading to inefficient use of computing resources and limited responsiveness.

In addition, many systems employing machine learning or generative models in the electronic commerce domain are optimized for generating narrative reports or recommendations, but they do not tightly couple the generated narrative with structured numerical indicators and visual representations that are derived from the same, well-defined integrated data set. This loose coupling makes it difficult for a user to directly trace each recommendation back to underlying metrics, hinders reproducibility of analyses, and obstructs automated comparison between multiple strategic scenarios.

Moreover, when a user issues follow-up instructions such as narrowing the target user segment, focusing on particular object groups, or altering campaign conditions conventional systems often re-run full analysis workflows from scratch or perform ad hoc extensions that ignore prior computed structures. This causes redundant data acquisition and recomputation, degrades real-time responsiveness, and limits the practical use of advanced generative models in interactive, multi-step decision support.

There is therefore a need for a computer-implemented system that technically improves the way in which a processor interprets natural-language analysis instructions, automatically acquires and normalizes heterogeneous data from multiple information resources, constructs and reuses a structured analysis context, and coordinates a generative AI model with deterministic data processing so as to generate, in a traceable and reproducible manner, both narrative strategy proposals and synchronized numerical and visual outputs. Such a system should further support iterative refinement of strategies through follow-up prompt sentences, while reusing an integrated data set in order to reduce computational overhead and improve the responsiveness and reliability of electronic commerce decision support.

The specific processing by the specific processing unit 290 of the data processing device 12 in Application Example 1 is realized by the following means.

The present invention provides a server comprising a processor and at least one memory storing instructions that, when executed by the processor, cause the processor to provide an information input/output interface for receiving an analysis instruction expressed in natural language from a user; obtain a prompt sentence including the analysis instruction and analysis conditions, perform natural language processing on the prompt sentence to extract an analysis target period, an analysis target classification, and an analysis target attribute, and, based on an extraction result, acquire target data from a free information resource, a paid information resource, and a user-specific information resource; perform preprocessing on the target data by executing, for numerical information, data formatting, missing-value completion, unit standardization, and aggregation computation, and, for character information, morphological analysis, normalization, sentiment classification, and topic classification, thereby generating preprocessed data; compute, from the preprocessed data, summary statistical values, representative indicators, classification-wise aggregation results, sentiment distributions, and topic distributions, and construct an analysis context in which these elements are structured and combined with the prompt sentence to form a prompt sentence for input to a generative AI model; input the prompt sentence and the analysis context to an external or internal generative AI model, execute reasoning processing by the generative AI model, and generate, in text format, insight information including tendencies, factors, risks, and improvement measures related to electronic commerce, and strategy proposals including sales measures, pricing measures, promotion measures, and inventory measures; calculate, based on the preprocessed data and the strategy proposals, visualization information indicating temporal transition information, classification comparison information, and indicator composition ratio information, and forecast indicators, effect indicators, and performance indicators, and structure the visualization information as graph information and numerical information; and associate text information generated by the generative AI model with the graph information and the numerical information, integrate the associated information as output data, transmit the output data to a user terminal via a communication path, and provide the output data in a format displayable in an interactive manner on the user terminal. This enables a technical improvement in computer-implemented electronic commerce analysis, by allowing the server to automatically interpret natural-language analysis instructions, construct and reuse an integrated and structured analysis context across heterogeneous data sources, coordinate deterministic data processing with generative reasoning, and interactively deliver traceable narrative strategies together with synchronized numerical and visual indicators in response to initial and follow-up prompt sentences, thereby reducing computational redundancy and improving responsiveness, reproducibility, and decision-making efficiency.

The term “analysis instruction” refers to a user's request, expressed in natural language, that specifies what kind of data analysis or strategic evaluation is to be performed by the system.

The term “prompt sentence” refers to a natural-language text string, including an analysis instruction and analysis conditions, which is used as an input to a natural language processing component and a generative AI model.

The term “analysis target period” refers to a time range, derived from the prompt sentence, that defines which temporal subset of data is to be included in the analysis.

The term “analysis target classification” refers to one or more categories, segments, or classes, derived from the prompt sentence, that specify how data is to be grouped or filtered for analysis.

The term “analysis target attribute” refers to one or more properties or features of objects or records, derived from the prompt sentence, that define which attributes are to be considered during analysis.

The term “free information resource” refers to an information source that can be accessed without payment of a fee, such as publicly available databases, open data services, or public application programming interfaces.

The term “paid information resource” refers to an information source that requires payment of a fee or a subscription for access, such as commercial data services, licensed databases, or premium application programming interfaces.

The term “user-specific information resource” refers to an information source that is owned, controlled, or exclusively associated with a particular user or organization, such as internal transaction logs, proprietary databases, or private data repositories.

The term “target data” refers to data records acquired from free information resources, paid information resources, and user-specific information resources in accordance with the analysis target period, the analysis target classification, and the analysis target attribute.

The term “preprocessed data” refers to data obtained by applying, to the target data, operations including formatting, missing-value completion, unit standardization, aggregation computation, and text-processing operations such as morphological analysis, normalization, sentiment classification, and topic classification.

The term “summary statistical values” refers to statistical indicators calculated from the preprocessed data, such as sums, averages, medians, variances, standard deviations, or quantiles.

The term “representative indicators” refers to numerical measures derived from the preprocessed data that summarize key aspects of performance or behavior, such as revenue per period, conversion rate, average rating, or repeat-purchase rate.

The term “classification-wise aggregation results” refers to aggregated values, computed from the preprocessed data, that are grouped by one or more classifications such as categories, segments, or classes.

The term “sentiment distribution” refers to a statistical representation of how sentiment classifications, such as positive, negative, or neutral, are distributed over reviews or other text data, optionally per classification or period.

The term “topic distribution” refers to a statistical representation of how identified topics or themes are distributed across text data, optionally per classification or period.

The term “analysis context” refers to a structured representation that combines summary statistical values, representative indicators, classification-wise aggregation results, sentiment distributions, topic distributions, and elements of the prompt sentence, and that is used as contextual input to a generative AI model.

The term “generative AI model” refers to a machine-implemented model trained on large data sets to generate or transform natural language or structured outputs, based on probabilistic or neural network-based inference, in response to an input prompt sentence and context.

The term “reasoning processing” refers to computation performed by the generative AI model whereby the model infers tendencies, relationships, explanations, or strategies from the analysis context and the prompt sentence.

The term “insight information” refers to explanatory or interpretive content generated by the generative AI model that describes tendencies, factors, risks, or improvement measures in relation to electronic commerce.

The term “strategy proposals” refers to recommended plans or courses of action generated by the generative AI model, including, for example, sales measures, pricing measures, promotion measures, and inventory measures.

The term “visualization information” refers to data that has been processed into a form suitable for graphical display, including temporal transition information, classification comparison information, and indicator composition ratio information.

The term “temporal transition information” refers to information that represents changes of indicators or metrics over time, such as time series of sales, ratings, or conversion rates.

The term “classification comparison information” refers to information that represents comparisons of indicators or metrics across classifications, such as categories, segments, or regions.

The term “indicator composition ratio information” refers to information that represents how an indicator is composed of subcomponents or segments, expressed as ratios, percentages, or shares.

The term “forecast indicators” refers to indicators that represent predicted future values of metrics, such as forecasted sales, demand, or inventory levels.

The term “effect indicators” refers to indicators that estimate or measure the expected or observed impact of a strategy, such as uplift in revenue, change in conversion rate, or change in inventory turnover.

The term “performance indicators” refers to indicators that quantify the performance of an activity or strategy, such as key performance indicators including revenue, profit, margin, or customer satisfaction.

The term “graph information” refers to data structures that define graphical representations, such as line charts, bar charts, or pie charts, derived from visualization information.

The term “numerical information” refers to data that expresses quantities, counts, or values in numerical form, including summary statistical values, indicators, and forecast values. The term “output data” refers to a structured combination of text information generated by the generative AI model, graph information, and numerical information, prepared for transmission to and display by a user terminal.

The term “user terminal” refers to an electronic device operated by a user, such as a computing device or communication device, that is capable of communicating with the server, receiving output data, and displaying interactive content.

The term “transaction history information” refers to records of past transactions, such as orders, purchases, or sales, including attributes such as time, object identifier, quantity, price, and user identifier.

The term “object attribute information” refers to descriptive data about objects subject to analysis, such as products or services, including attributes such as category, specification, feature, or tag.

The term “evaluation information” refers to data representing assessments made by users or customers, such as ratings, reviews, feedback messages, or evaluation scores.

The term “market trend information” refers to data describing temporal patterns or movements in a market, such as changes in demand, prices, or market size over time.

The term “competitor information” refers to data regarding other entities operating in the same or related markets, including their prices, offerings, promotions, or market positions.

The term “seasonality information” refers to data that represents periodic or seasonal patterns affecting demand, behavior, or performance, such as variations by month, quarter, or holiday period.

The term “integrated data set” refers to a data structure resulting from mapping and combining heterogeneous data, including transaction history information, object attribute information, evaluation information, and external information, onto a common time axis and a common classification scheme.

The term “follow-up prompt sentence” refers to a prompt sentence received from the user after an initial analysis, which refines, restricts, or extends the analysis instruction, such as by changing a target user segment, a target object group, or measure conditions.

The term “past analysis result identification information” refers to data that identifies or references a previously generated analysis or strategy proposal, enabling the system to relate a follow-up prompt sentence to prior context.

The term “target user segment” refers to a subset of users defined by one or more attributes, such as demographic characteristics, purchase behavior, or value category, to which a strategy proposal is directed.

The term “target object group” refers to a subset of objects, such as products or services, defined by one or more attributes or classifications, to which a strategy proposal is directed.

The term “measure conditions” refers to parameters or constraints that define how a strategy is to be implemented, such as discount rates, campaign periods, budget limits, or inventory constraints.

In one embodiment, a server executes a computer program that is stored in a non-transitory computer-readable medium and that configures the server to perform analysis and strategy generation for electronic commerce data. The server comprises at least one processor, a main memory, a persistent storage device, and a network interface. The server operates under an operating system such as a general-purpose server operating system and communicates with one or more terminals via a communication network such as the Internet.

The terminal comprises a portable communication device, for example a smartphone, including a display panel, a touch input interface, a local processor, a local memory, and a wireless communication module. A user operates the terminal to provide analysis instructions and to view results.

The server uses an information input/output module to receive an analysis instruction expressed in natural language as a prompt sentence from the user. The terminal presents, on its display, a text input field, option selectors for time ranges, categories, and segments, and a send button. The user enters the prompt sentence through the touch interface. Example prompt sentences include:

“Analyze my past three years of sales and customer reviews and propose a strategy to increase sales during the summer sale. Focus on outdoor and sports categories.”

“Next, analyze this dataset and propose strategies to increase sales during the summer sale. The data includes sales data and customer reviews from the past three years. Highlight which product categories should be prioritized and what type of promotion (discounts, bundles, or free shipping) will be most effective.”

The terminal converts the prompt sentence and selected options into a structured message and transmits it via an encrypted protocol such as HTTPS to an application programming interface exposed by the server.

The server executes a natural language processing module implemented, for example, using a neural network library running on the processor. The server applies a sequence of operations to the received prompt sentence, including tokenization, part-of-speech tagging, named entity recognition, and dependency parsing. The server uses a language model such as a transformer-based encoder that has an embedding layer, multiple self-attention layers, feed-forward layers, and layer normalization. The model parameters have been trained in advance using a corpus of task-relevant text, so that time expressions, category names, and business objectives can be recognized with high accuracy.

The server translates expressions such as “past three years” or “next summer sale” into a concrete analysis target period by mapping these expressions to start and end timestamps.

The server identifies an analysis target classification by mapping words such as “outdoor and sports categories” to internal category codes stored in a taxonomy table. The server identifies analysis target attributes such as “premium customers,” “slow-moving items,” or “high-margin products” and maps them to flags or attribute identifiers used in internal databases. The server stores the extracted analysis target period, analysis target classification, and analysis target attributes in a structured in-memory data structure, such as a key-value map or a record object, which forms part of an analysis context.

The server accesses a plurality of information resources. The server connects to a free information resource, such as a public data repository accessed via an HTTP interface, to obtain general market statistics, public trend indices, or holiday calendars. The server connects to a paid information resource, such as a commercial data service accessible through a secure application programming interface, to obtain competitor pricing data, category trend indices, or external demand estimates. The server connects to a user-specific information resource, such as a relational database management system storing transaction history information and object attribute information, and a document store or log storage system storing evaluation information such as reviews and ratings. The server uses structured query language or document queries to retrieve only those records whose timestamps fall within the extracted analysis target period and whose category codes match the analysis target classification. This targeted retrieval reduces data volume and contributes to improved processing speed and reduced memory usage.

The server performs preprocessing on the acquired target data using a data processing library executed on the processor. For numerical information such as sales amounts, quantities, prices, and ratings, the server performs data formatting by converting all records into consistent numeric types and time zones, missing-value completion by filling null values with statistically appropriate substitutes such as means or medians, unit standardization by converting multiple currencies or units into a common base unit using conversion tables, and aggregation computation by grouping records according to the analysis target period and the analysis target classification. The server stores aggregated results in table structures such as arrays or columnar tables, computing summary statistics including sums, averages, standard deviations, and percentiles.

For character information such as textual reviews, feedback comments, and product descriptions, the server executes morphological analysis or tokenization appropriate for the language of the text, and performs normalization operations such as lowercasing, stop-word removal, lemmatization, and punctuation filtering. The server applies a sentiment classification model implemented as a neural network classifier with an embedding layer, one or more recurrent or transformer layers, and a final softmax output layer, trained on labeled review data. The classifier outputs sentiment scores and assigns each review to sentiment classes such as positive, neutral, or negative. The server also executes a topic classification or topic modeling algorithm. In one embodiment, the server uses a supervised text classifier that maps each review to one or more topic labels, such as “delivery speed,” “product quality,” “price value,” or “seasonal suitability,” using a multi-label neural network with sigmoid outputs. In another embodiment, the server uses an unsupervised algorithm such as latent Dirichlet allocation to identify topics based on co-occurrence of words within the corpus of reviews.

The server aggregates sentiment scores and topic labels per object, per category, and per time period to form sentiment distributions and topic distributions. The server stores these distributions as arrays or histograms, which are referenced by keys representing the object identifier, time bucket, and classification. Because the server computes these distributions on the basis of preprocessed and normalized textual features, the distributions are comparable across different time periods and categories, which improves the precision of subsequent analysis.

The server constructs an analysis context by combining the preprocessed data, summary statistical values, representative indicators, classification-wise aggregation results, sentiment distributions, topic distributions, and the structured representation of the prompt sentence.

The server represents the analysis context in a machine-readable form such as a hierarchical object or a structured document that contains sections for numerical summaries, text summaries, and parameter settings. The server flattens or encodes this analysis context into a compact representation suitable for input to a generative AI model. For example, the server transforms tables into condensed textual descriptions or applies dimensionality reduction techniques to numerical matrices to derive feature vectors.

The server constructs a new prompt sentence for the generative AI model by embedding the user's original language, a concise restatement of the analysis target period and classifications, and selected numerical summaries and review insights. The server uses fixed templates or learned formatting rules to ensure that key data values are embedded in a predictable structure, which allows the generative AI model to attend to relevant parts of the input more effectively. An internal prompt may have the form:

“Using the following data summaries, act as a strategy generator for an electronic commerce platform. User's request: ‘Analyze my sales and customer reviews for the last three years and propose a strategy to increase sales in the summer sale.’ Sales summary: [summarized metrics]. Review insight summary: [sentiment and topic statistics]. Generate: (1) key insights, (2) recommended actions, (3) suggested indicators to monitor.”

The server uses a generative AI model implemented as a deep neural network, for example a transformer-based language model comprising an embedding layer, a plurality of self-attention blocks, feed-forward layers, and an output projection layer that maps hidden states to a vocabulary distribution. The model has been trained using a combination of unsupervised language modeling and supervised fine-tuning on task-specific data, such as example analyses and strategies. During training, the server uses a loss function such as cross-entropy between predicted tokens and ground-truth tokens, and optimizes parameters using a gradient-based algorithm such as stochastic gradient descent with adaptive learning rates. The server may employ regularization techniques such as dropout, layer normalization, and data augmentation through paraphrasing or noise injection on training text.

At runtime, the server encodes the constructed prompt sentence using the model's tokenizer and feeds the resulting token sequence into the generative AI model. The server controls generation using parameters such as temperature, top-k or top-p sampling thresholds, and maximum length. The model outputs tokens representing an analysis narrative and strategy proposals. Importantly, the server constrains the generation by including structured cues in the prompt so that the generative AI model aligns its output sections with numerical metrics and topics already computed by the deterministic modules. This alignment enables the server to correlate each recommendation with underlying statistics, which supports traceability and verification, improving reliability beyond mere automation of human drafting.

The server generates text-based outputs such as identification of trends (“sales of cooling bedding increased year-over-year in July”), explanations of causal relationships (“negative sentiment about delivery delays correlates with reduced repeat purchases”), and concrete strategy proposals (“apply a moderate discount to lightweight outdoor gear in early June and highlight cooling features”). The generative AI model does not directly access raw databases; instead, the server mediates all inputs through the analysis context and deterministic preprocessing. This separation reduces attack surfaces and helps maintain data security and consistency.

The server also constructs visualization information by processing the preprocessed data and selected strategy proposals. The server computes time-series arrays for key indicators, category comparison tables for specific metrics, and composition ratios for multi-component indicators. The server uses a visualization library executed on the processor to map these structures to graph information, such as definitions of line charts, bar charts, and pie charts, including axis ranges, labels, colors, and data series identifiers. The server generates numerical information representing forecast indicators, effect indicators, and performance indicators. For forecasting, the server may apply a time-series model such as an autoregressive integrated moving average model, a regression model using external indices, or a neural network-based predictor. The server computes predicted values and associated uncertainty ranges, which allows the user to evaluate different scenarios.

The server associates text segments from the generative AI output with particular graphs and numerical indicators by embedding identifiers or reference tags in both structures. For example, a recommendation that refers to “Strategy 1” is linked in the internal data structures to a specific set of forecast curves and effect indicators. When the terminal displays the results, the user can select a recommendation and see the directly related charts, or select a chart and view the corresponding narrative explanation. This cross-linking is implemented in the data structures on the server and terminal and constitutes a technical improvement in data navigation and decision support.

The server transmits an integrated output data set to the terminal. The output data set includes narrative text, graph definitions, and numerical tables, encoded in a machine-readable format. The terminal receives the output data, parses it, and renders the narrative in text views, and the graphs using a chart rendering module executed on the local processor. Because the server has pre-aggregated and pre-formatted the data, the terminal requires less computation and memory, contributing to reduced power consumption on the portable device and faster user interface responsiveness.

The server further supports iterative refinement by receiving follow-up prompt sentences from the user. When the user inputs a follow-up instruction such as “Based on the previous analysis, refine the strategy for premium customers only and suggest cross-selling opportunities with high-margin products,” the terminal includes an identifier of the previous analysis in the message to the server. The server retrieves or references the existing integrated data set and analysis context and modifies only the target user segment, target object group, or measure conditions. The server avoids re-acquiring and re-preprocessing all raw data, thereby reducing communication load and redundant computation. This incremental reuse of preprocessed data and cached intermediate results leads to improved throughput and reduced latency, especially when multiple users perform iterative analyses concurrently.

The server updates the analysis context to include the new constraints and constructs a new prompt sentence for the generative AI model that explicitly references the previous scenario and highlights the changed parameters. The generative AI model generates revised strategy proposals and updated indicator predictions, which the server again links with visualization information and transmits to the terminal. Because the system maintains a stable, integrated data set and adjusts only the parameters and context fed into the generative AI model, the differences between scenarios can be accurately quantified and presented in a consistent manner, improving precision and reducing interpretive errors compared with ad hoc manual recalculations.

From a technical standpoint, the described configuration improves computer technology in several ways. The server automatically converts unstructured natural language instructions into structured analysis parameters and constraints through trained models and deterministic parsing. This reduces the need for manual query construction and eliminates a common source of human error in specifying analysis conditions. The structured analysis context allows the server to avoid repeatedly executing full retrieval and preprocessing pipelines for every user interaction, thereby reducing processor load, memory usage, and network traffic. The tight coupling between deterministic data processing modules and the generative AI model, achieved through structured prompts and explicit context encoding, ensures that generated text remains synchronized with numerical and graphical outputs, which increases the reliability and traceability of computer-generated strategies.

The use of neural network architectures with explicit feature extraction and sentiment/topic modeling yields more accurate and consistent analysis than simple keyword searches or rule-based systems, especially for large volumes of heterogeneous reviews. The training procedures, including the use of supervised and unsupervised learning, loss functions, and gradient-based optimization, provide a concrete, non-abstract implementation that leverages the processing capabilities of the server. The integration of these models with specific data structures, caching strategies, and incremental update mechanisms yields improved performance characteristics such as lower response time, reduced recomputation, and higher throughput for interactive, multi-step analysis sessions.

The system is not limited to a single architecture. In an alternative embodiment, the server uses a different neural network model, such as a recurrent neural network, for sentiment and topic analysis, or a different generative AI model for strategy generation. In another embodiment, the free, paid, and user-specific information resources are provided by different database systems or storage backends. In yet another embodiment, the terminal is a non-portable computing device such as a desktop workstation, and the communication network is a local area network. In all cases, the core operations natural-language analysis instruction interpretation, structured analysis context construction, integrated data set management, coordinated generative AI processing, and interactive visualization are performed by the server in a way that improves how the computer system processes, manages, and presents complex multi-source data for decision making, rather than merely automating a human mental process.

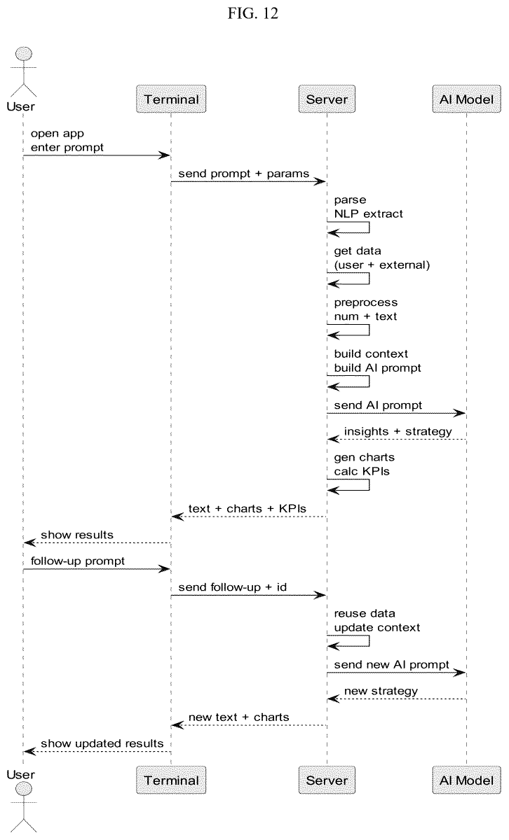

The following describes the processing flow using FIG. 12.

### Step 1:

User operates the terminal to issue an analysis request.

User launches an application on the terminal and inputs a prompt sentence in natural language, such as “Analyze my past three years of sales and customer reviews and propose a strategy to increase sales during the summer sale. Focus on outdoor and sports categories.”

Input: raw text prompt sentence and optional settings (for example, period selector, category selector).

Output: structured request data at the terminal, including the prompt sentence and selected options.

### Step 2:

Terminal transmits the structured request to the server.

Terminal packages the prompt sentence, the selected analysis period, category filters, and a user identifier into a structured message and sends it via a secure communication protocol to the server.

Input: structured request data generated in Step 1.

Output: network message delivered to the server that contains the prompt sentence and analysis parameters.

### Step 3:

Server validates and parses the received request.

Server authenticates the user based on the user identifier or token contained in the message, checks the integrity of the data, and extracts the prompt sentence and explicit analysis parameters into internal variables.

Input: network message received from the terminal.

Output: validated prompt sentence and basic analysis parameters stored in server memory.

### Step 4:

Server performs natural language processing on the prompt sentence.

Server applies tokenization, part-of-speech tagging, and named entity recognition to the prompt sentence using a language model, and detects expressions representing time ranges, categories, and attributes. Server converts expressions such as “past three years” into concrete start and end timestamps, maps category names such as “outdoor and sports” to internal classification codes, and identifies target attributes such as “premium customers” or “high-margin products.”

Input: validated prompt sentence from Step 3.

Output: extracted analysis target period, analysis target classification, and analysis target attributes stored as structured fields.

### Step 5:

Server retrieves user-specific data according to the extracted conditions.

Server formulates database queries that filter transaction history information, object attribute information, and evaluation information based on the analysis target period and analysis target classification. Server executes the queries against internal data stores and obtains records such as orders, product metadata, and customer reviews.

Input: analysis target period, analysis target classification, analysis target attributes from Step 4.

Output: sets of raw transaction records, object attribute records, and evaluation records loaded into memory as target data.

### Step 6:

Server retrieves external free data and paid data.

Server sends requests to free information resources to obtain public market trend information, seasonality information, and general indices for the relevant categories and time frame.

Server also sends authenticated requests to paid information resources to acquire competitor information, detailed market indices, and external demand estimates.

Input: analysis target period and analysis target classification from Step 4.

Output: external data records from free and paid information resources, aligned in coarse form with internal target data.

### Step 7:

Server integrates heterogeneous data into an intermediate target data collection.

Server merges user-specific data and external data by aligning on common keys such as time buckets, category codes, and object identifiers. Server resolves discrepancies in identifiers and formats, and stores the merged information in a unified table or set of linked tables.

Input: internal target data from Step 5 and external data from Step 6.

Output: integrated target data collection representing all relevant information for the requested analysis.

### Step 8:

Server preprocesses numerical information.

Server executes data formatting by converting numerical fields to consistent types and units, performs missing-value completion by filling in null or missing entries using statistical functions, and applies unit standardization for currencies and measurements. Server then computes aggregated metrics by grouping records over time and classifications, calculating sums, averages, variances, and other summary statistics.

Input: integrated target data collection from Step 7.

Output: preprocessed numerical data tables containing cleaned and aggregated metrics.

### Step 9:

Server preprocesses textual information.

Server extracts textual fields from evaluation information, such as review comments and feedback messages, and applies tokenization, normalization, and filtering of stop words.

Server applies a sentiment classification model to assign sentiment scores to each text and a topic classification or topic modeling algorithm to identify topics associated with each text.

Input: textual portions of the integrated target data collection from Step 7.

Output: sentiment-annotated and topic-annotated text records, with associated sentiment scores and topic labels.

### Step 10:

Server aggregates sentiment and topic information.

Server groups the annotated text records by object identifier, category, and time period, and computes distributions of sentiment classes and frequencies of topics. Server stores these results as sentiment distributions and topic distributions that correspond to specific objects and time buckets.

Input: sentiment-annotated and topic-annotated records from Step 9.

Output: aggregated sentiment distributions and topic distributions organized by object, category, and period.

### Step 11:

Server computes summary indicators and constructs an analysis context.

Server combines preprocessed numerical data, sentiment distributions, and topic distributions to compute representative indicators such as revenue per period, conversion rates, average ratings, repeat-purchase rates, and topic-specific satisfaction measures. Server stores these indicators, together with extracted conditions and a structured representation of the prompt sentence, in an analysis context data structure.

Input: preprocessed numerical data from Step 8 and aggregated sentiment/topic data from Step 10.

Output: analysis context containing summary statistical values, representative indicators, classification-wise aggregation results, sentiment distributions, topic distributions, and parameter settings.

### Step 12:

Server generates a prompt sentence for the generative AI model.

Server formats a new prompt sentence that embeds the user's original request, a summary of the analysis context, and explicit instructions for the type and structure of the desired output.

Server selects and compresses numerical indicators and review insights into concise textual descriptions and concatenates them with template phrases to form a detailed instruction.

Input: analysis context from Step 11 and original prompt sentence from Step 4 Output: constructed prompt sentence tailored for input to the generative AI model.

### Step 13:

Server executes the generative AI model to produce narrative insights and strategies.

Server tokenizes the constructed prompt sentence, feeds the resulting token sequence into a generative AI model such as a transformer-based language model, and activates decoding to generate output tokens. The model, using its trained parameters, computes attention weights and hidden states over the input and iteratively produces tokens that form natural-language descriptions of insights and strategy proposals.

Input: constructed prompt sentence from Step 12.

Output: generated narrative text containing insight information and strategy proposals.

### Step 14:

Server post-processes generated narrative text.

Server parses the generated text to identify sections such as “Key Insights,”

“Recommendations,” and “Indicators to Monitor,” and verifies internal consistency with the analysis context. Server may insert identifiers or tags that reference underlying indicators or graphs to enable later linkage.

Input: raw narrative text from Step 13 and analysis context from Step 11.

Output: structured narrative content segmented into labeled sections and annotated with internal references.

### Step 15:

Server calculates visualization information and indicators for display.

Server uses the preprocessed numerical data and forecast models to compute temporal transition series, classification comparison tables, and composition ratios for key indicators referred to in the narrative. Server calculates forecast indicators, effect indicators, and performance indicators for one or more scenarios, including baseline and strategy-applied conditions.

Input: preprocessed numerical data from Step 8, analysis context from Step 11, and strategy proposals from Step 14.

Output: arrays and tables representing visualization information and indicators ready for graph generation.

### Step 16:

Server generates graph information and numerical output structures.

Server converts the visualization information into graph definitions, specifying types of charts, axes, labels, color schemes, and data series identifiers. Server packages numerical indicators into structured tables with explicit column names and row labels.

Input: visualization information and indicators from Step 15.

Output: graph information structures and numerical information structures suitable for transmission and rendering.

### Step 17:

Server integrates narrative, graph, and numerical information into an output data set.

Server associates each recommendation and insight with specific graphs and numerical tables by attaching common identifiers, and combines all components into a single output data object. Server adds metadata describing analysis period, data sources used, and scenario identifiers.

Input: structured narrative content from Step 14 and graph/numerical structures from Step 16.

Output: integrated output data set containing linked text, graphs, numbers, and metadata.

### Step 18:

Server transmits the integrated output data set to the terminal.

Server serializes the output data set and sends it to the terminal over the network using an application-level protocol.

Input: integrated output data set from Step 17.

Output: serialized response message delivered to the terminal.

### Step 19:

Terminal receives and renders the analysis results.

Terminal deserializes the response, extracts narrative sections, graph definitions, and numerical tables, and displays the narrative text on the screen. Terminal uses a chart rendering component to draw graphs according to the received graph definitions and may allow the user to interact with charts, such as by tapping or zooming.

Input: serialized response message from Step 18.

Output: rendered user interface on the terminal displaying insights, strategies, graphs, and numerical values.

### Step 20:

User reviews results and optionally issues a follow-up prompt sentence.

User examines the displayed information, compares alternative strategies or indicators, and, if needed, inputs a follow-up prompt sentence such as “Based on the previous analysis, refine the strategy for premium customers only and suggest cross-selling opportunities with high-margin products.” The terminal includes an identifier of the current analysis session and sends a new request.

Input: displayed analysis results from Step 19 and user interaction on the terminal.

Output: new structured request data, including a follow-up prompt sentence and context identifier, which can be processed again starting from Step 2.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional data analysis systems that incorporate machine learning and natural language interfaces typically treat user instructions and underlying datasets in a static and loosely coupled manner. In many implementations, a user uploads data, inputs a free-form query, and a model returns a one-shot textual answer generated directly from the raw data or from simplistic statistics. Such systems suffer from several technical limitations. First, existing systems often lack a structured, processor-controlled pipeline that normalizes heterogeneous data sources and converts them into analysis-ready datasets in a way that is explicitly conditioned on a user's natural language prompt. As a result, the processing unit may repeatedly perform redundant or inappropriate data transformations, which leads to inefficient use of memory and processing resources, and can degrade responsiveness and throughput in multi-user environments.

Second, conventional systems typically feed either unprocessed or minimally summarized data directly into a generative AI model. Without an adaptive summarization mechanism that selects indices, periods, and classification axes according to the semantics of the prompt sentence, the model input may include irrelevant or noisy information. This can cause bloated model inputs, increased latency, unnecessary consumption of computational resources, and unstable quality of generated insights, thereby impairing the overall effectiveness of the computer system.

Third, many known solutions generate textual analyses and visualizations as separate, unlinked artifacts. The processing unit often lacks machine-readable correspondence between specific textual statements and the underlying quantitative indicators or visual elements. This deficiency prevents the system from providing interaction patterns in which a user can reliably trace each part of the narrative back to a particular metric or visualization.

Consequently, the human-computer interaction remains fragile, and it is difficult for the system to support iterative, prompt-driven refinement while preserving consistency between text and visuals.

Fourth, iterative analysis workflows are frequently treated as independent sessions from the standpoint of the processing logic. When a user issues follow-up prompt sentences, conventional systems often re-ingest and reprocess the same data or ignore the previously computed intermediate summaries. This leads to repeated computations, unnecessary access to storage, and longer response times, and it hinders the ability of the system to maintain a coherent, evolving analysis context across multiple user prompts.

Accordingly, there is a need for an improved computer-implemented system in which a processor controls: (i) data preprocessing tailored to heterogeneous input; (ii) prompt-aware summarization that constructs compact, relevant input information for a generative AI model; (iii) maintenance of explicit associations between textual analysis results and visual information; and (iv) reuse of an analysis dataset across iterative prompt sentences. Such a system can improve the efficiency, reliability, and interactivity of prompt-driven data analysis performed by a computer, and can thereby constitute a concrete improvement to computer technology itself, rather than merely automating a mental process.

The specific processing by the specific processing unit 290 of the data processing device 12 in Example 2 is realized by the following means.

The present invention provides a server comprising a processor configured to receive analysis target information and a natural-language prompt sentence from a user terminal, to determine a format of the analysis target information and perform preprocessing including completion of missing values, exclusion of abnormal values, normalization of formats, and derivation of attributes so as to generate an analysis dataset, to generate prompt-aware summary information from the analysis dataset based on contents of the prompt sentence, the summary information including at least one of time series aggregation, category-wise aggregation, statistical value calculation, classification processing, and clustering processing, and to construct input information for a generative AI model including the summary information and the prompt sentence; the processor is further configured to execute the generative AI model using the input information to generate analysis result text expressed in natural language, to generate visual information based on the analysis dataset and the analysis result text, the visual information including at least one of time-series visualization, category-wise comparison visualization, and distribution visualization, and to maintain an association between elements of the visual information and description units in the analysis result text by managing correspondence information between the description units and indices in the summary information; the processor is still further configured to generate response information including the analysis result text and the visual information as constituent information and to transmit the response information to the user terminal, and to receive an additional prompt sentence from the user terminal, reconstruct the input information for the generative AI model while reusing the analysis dataset and dynamically selecting indices, periods, and classification axes according to an analysis type extracted from the additional prompt sentence, and update and iteratively provide the analysis result text and the visual information. This enables the computer system to perform more efficient and context-aware data analysis by reducing redundant preprocessing, by constructing compact and relevant inputs for the generative AI model, by preserving explicit links between textual insights and visual elements, and by supporting iterative, prompt-driven refinement over a persistently maintained analysis dataset, thereby improving the technical performance and usability of data analysis operations executed by the server.

The term “user terminal” refers to an information processing apparatus operated by a user, such as a general-purpose computing device or communication device, that is configured to transmit analysis target information and prompt sentences to a server and to receive and present response information including analysis result text and visual information.

The term “analysis target information” refers to digital information serving as a subject of analysis, including but not limited to tabular data, time-series data, categorical data, and numerical or textual records, which may be obtained from various data sources such as public data, commercial data, or proprietary data.

The term “prompt sentence” refers to natural-language input provided by a user, including an analysis objective, constraints, or focus points, which is used by a processor to control data preprocessing, summarization, and execution of a generative AI model.

The term “analysis dataset” refers to a structured information set generated from analysis target information by preprocessing operations, the structured information set being formatted and cleansed to be suitable for subsequent statistical processing and generative AI model analysis.

The term “preprocessing” refers to a series of data transformation operations executed by a processor on analysis target information, including at least completion of missing values, exclusion of abnormal values, normalization of formats, and derivation of attributes, in order to produce an analysis dataset.

The term “completion of missing values” refers to a data processing operation in which absent or null entries in analysis target information are filled with substituted values according to predetermined rules or algorithms so as to improve consistency and usability of the dataset.

The term “exclusion of abnormal values” refers to a data processing operation in which data points that deviate from expected ranges or patterns according to predetermined criteria are removed or isolated from an analysis dataset to reduce noise and improve analysis reliability.

The term “normalization of formats” refers to a data processing operation in which heterogeneous representations of similar information, such as date formats, numeric formats, or categorical labels, are converted into a unified representation within an analysis dataset.

The term “derivation of attributes” refers to a data processing operation in which new data fields are computed from existing fields, such as calculating time-based fields, ratio metrics, or category groupings, to enrich the analysis dataset.

The term “summary information” refers to compact information derived from an analysis dataset by aggregating, grouping, or transforming the underlying data, including but not limited to time series aggregation, category-wise aggregation, statistical value calculation, classification processing, and clustering processing.

The term “time series aggregation” refers to a summarization operation in which data is grouped and aggregated over temporal intervals, such as days, months, or quarters, to produce time-indexed metrics.

The term “category-wise aggregation” refers to a summarization operation in which data is grouped and aggregated according to categorical attributes, such as product types, regions, or user segments, to produce category-indexed metrics.

The term “statistical value calculation” refers to a summarization operation in which statistical indicators, such as mean, median, variance, or percentile values, are computed from values in an analysis dataset.

The term “classification processing” refers to an information processing operation in which data records are assigned to predefined or learned classes according to one or more rules or models to distinguish different categories or labels.

The term “clustering processing” refers to an information processing operation in which data records are partitioned into groups based on similarity measures without using predefined labels, thereby identifying clusters or segments within the data.

The term “input information for a generative AI model” refers to information provided to a generative AI model by a processor, the information including at least summary information and a prompt sentence, optionally combined with system-level instructions or contextual metadata.

The term “generative AI model” refers to a machine learning model configured to generate natural-language text or other content in response to input information, the model being trained on large-scale data and capable of producing analysis result text conditioned on summary information and prompt sentences.

The term “analysis result text” refers to natural-language output generated by a generative AI model, including explanations, insights, interpretations, or recommendations derived from summary information and controlled by a prompt sentence.

The term “visual information” refers to information representing data or analysis results in a visual form, including but not limited to graphs, charts, plots, or other graphical elements, such as time-series visualizations, category-wise comparison visualizations, and distribution visualizations.

The term “time-series visualization” refers to visual information that represents variation of one or more metrics over time, typically using graphical forms such as line graphs, area charts, or bar charts indexed by time.

The term “category-wise comparison visualization” refers to visual information that represents comparative values of metrics among different categories, such as entities, groups, or segments, typically using graphical forms such as bar charts, grouped bars, or stacked charts.

The term “distribution visualization” refers to visual information that represents the distribution of values within a dataset, such as histograms, box plots, or scatter plots that show ranges, densities, or clusters.

The term “description unit” refers to a logically distinguishable segment of analysis result text, such as a sentence, clause, paragraph, or list item, which conveys a specific insight, explanation, or recommendation.

The term “index” refers to a quantitative or qualitative indicator computed or identified within summary information, such as a metric, statistic, aggregated value, or segment identifier, which serves as a reference for analysis and visualization.

The term “correspondence information” refers to machine-readable information that defines associations between description units in analysis result text and indices in summary information, enabling linkage between textual content and underlying quantitative or categorical indicators.

The term “association between elements of the visual information and description units” refers to a relationship maintained by a processor such that specific graphical elements, such as lines, bars, or points, are linked to corresponding description units, thereby allowing coordinated presentation or interaction.

The term “response information” refers to information generated by a processor for transmission to a user terminal, including at least analysis result text and visual information, and optionally including metadata describing analysis context or model settings.

The term “analysis type” refers to a classification of an analytical objective indicated by a prompt sentence, such as trend analysis, anomaly detection, segmentation, or comparison, which is extracted by a processor and used to control configuration of summary information and model input.

The term “indices, periods, and classification axes” refers to, respectively, metrics or indicators selected for summarization, temporal ranges or granularities over which data is aggregated, and categorical dimensions along which data is grouped, all of which are dynamically determined based on an analysis type.

The term “iteratively provide” refers to an operational mode in which a processor repeatedly generates and updates analysis result text and visual information in response to multiple prompt sentences, while maintaining and reusing an existing analysis dataset to preserve analysis context.

In one embodiment, a server cooperates with one or more terminals operated by a user to implement the claimed system. The server includes at least one processor, a main memory, a non-volatile storage device, and a network interface. The processor may be a general-purpose central processing unit or a combination of a central processing unit and a graphics processing unit. The main memory may be a volatile semiconductor memory. The non-volatile storage device may be a magnetic disk device, a solid-state storage device, or a similar storage apparatus. The network interface connects the server to a communication network and enables bidirectional communication with the terminal.

The terminal includes at least a processor, a memory, a display, an input device, and a communication interface. The terminal may be a personal computer, a smartphone, a tablet, or another information processing apparatus capable of executing a web browser or a dedicated client application. The terminal executes a client-side program, such as a web browser application, and the terminal presents a graphical user interface that allows the user to provide analysis target information and a prompt sentence.

In one embodiment, the server stores a plurality of software modules in the non-volatile storage device. The server loads these modules into the main memory and the processor executes the modules. The modules may include, for example, a web application framework module, a data preprocessing module, a summary generation module, a generative AI interface module, a visualization generation module, a correspondence management module, and a response generation module. The web application framework module may be implemented by common server-side frameworks, such as a scripting language-based web framework or a compiled language-based web framework. The data preprocessing module and summary generation module may be implemented using a data analysis library such as a numerical computation library or a distributed data processing framework. The visualization generation module may be implemented using a plotting library or a browser-based visualization framework. The generative AI interface module may interface with a generative AI model implemented as a transformer-based neural network executed on a graphics processing unit.

The server uses the data preprocessing module to transform heterogeneous analysis target information into an analysis dataset. The server may obtain analysis target information in a tabular format such as a comma-separated values file or in a structured format such as a structured JavaScript object representation. The server stores the raw analysis target information in a storage structure such as a relational database table, a columnar data store, or a key-value store. The server then applies a sequence of preprocessing operations that include completion of missing values, exclusion of abnormal values, normalization of formats, and derivation of attributes.

The server may use a numerical computation library to scan each column of a tabular dataset and to compute basic statistics, such as a mean and a standard deviation, which the server uses to identify abnormal values exceeding a threshold. The server may exclude abnormal values by removing rows from the dataset or by replacing outliers with boundary values. The server may detect missing values and complete them by applying rules such as median imputation or last-observation-carried-forward depending on the type of the attribute. The server may normalize formats by converting date strings to a unified internal representation, by converting localized numeric formats to a standard decimal representation, and by mapping textual categories to canonical identifiers. The server may derive additional attributes, such as a year attribute, a month attribute, or a growth-rate attribute computed by comparing values across time intervals. The server stores the resulting cleaned and enriched dataset as the analysis dataset in a structured data store.

The server uses the summary generation module to transform the analysis dataset into summary information that is conditioned on the user's prompt sentence. The server receives a prompt sentence from the terminal through the web application framework module. The prompt sentence may be a natural-language instruction such as “Analyze the recent sales performance of each competitor, highlight major trends, and propose three strategic actions for the next quarter.” The server may tokenize the prompt sentence and classify it into one or more analysis types, such as trend analysis, anomaly detection, or segmentation, by applying a natural language processing model or a rule-based classifier.

Based on the identified analysis type, the server selects indices, periods, and classification axes that are relevant to the requested analysis. For example, for trend analysis, the server selects time-based indices such as monthly total sales and uses the year and month attributes as classification axes. For segmentation, the server selects group-wise indices such as average revenue per customer and uses customer category attributes as classification axes. The server uses a data analysis library to compute time series aggregation, category-wise aggregation, and statistical values such as means, medians, and percentiles. The server may also invoke algorithms such as clustering (for example, k-means clustering) or classification (for example, decision trees) to segment entities based on multi-dimensional feature vectors constructed from the analysis dataset.

The server then constructs summary information as a structured representation that includes aggregated metrics indexed by time, category, or cluster, together with metadata describing each index and the applied aggregation method. The server ensures that the summary information is compact enough to meet input size constraints imposed by the generative AI model. The server may perform sampling or dimensionality reduction to limit the number of groups, time intervals, or features included in the summary information.

The server uses the generative AI interface module to construct input information for the generative AI model from the summary information and the prompt sentence. In one embodiment, the generative AI model is a transformer-based neural network trained on a large corpus of natural-language text and structured data descriptions. The model may comprise multiple layers of self-attention blocks, each block including multi-head attention sub-layers and feed-forward sub-layers, with parameters learned by stochastic gradient descent under a cross-entropy loss function during a pre-training phase. The server formats the summary information and the prompt sentence into a sequence of tokens in accordance with the tokenization scheme of the generative AI model. The server may prepend a system-level instruction that constrains the behavior of the model, such as an instruction to behave as a data analyst and to reference specific indices by name.

The server transmits the tokenized input information to the generative AI model. The generative AI model generates output tokens representing analysis result text. The model computes a probability distribution over vocabulary tokens at each position using the learned attention weights and feed-forward parameters, and the server selects tokens according to a decoding strategy such as greedy decoding or nucleus sampling. The server collects the sequence of output tokens corresponding to the analysis result text and decodes them into a natural-language string.

The server uses the correspondence management module to maintain an association between description units in the analysis result text and indices in the summary information. The server may identify references in the text to particular indices by performing pattern matching on index names or aliases embedded in the input to the generative AI model. In another embodiment, the server may instruct the generative AI model to output structured tags that explicitly indicate which index or group each description unit refers to. The server stores, in a correspondence table, pairs of description-unit identifiers and index identifiers. This table allows the server to later link parts of the narrative to specific aggregated metrics. The server uses the visualization generation module to generate visual information from the analysis dataset and the summary information. The server selects visualization types according to the classification axes and indices. For time series aggregation, the server may generate a line chart or bar chart representing the temporal evolution of an index. For category-wise aggregation, the server may generate bar charts or stacked bar charts representing comparisons across categories. For distribution analysis, the server may generate histograms, box plots, or scatter plots. The server uses a plotting library executed on the server to render the charts into an image format suitable for display by the terminal, or the server generates a structured specification that can be interpreted by a browser-side visualization library.

The server embeds identifiers in the visual information that correspond to the index identifiers in the summary information. The server can then consult the correspondence table to associate graphical elements of a chart, such as individual bars or lines, with specific description units in the analysis result text. This association allows the terminal to implement coordinated visual highlighting, for example by emphasizing a chart element when the user selects a corresponding textual statement.

The server uses the response generation module to assemble response information that includes the analysis result text, the visual information, and optional metadata such as the analysis type and the time range covered by the analysis. The server sends the response information through the network interface to the terminal. The terminal receives the response information, and the terminal displays the analysis result text in a textual area of the user interface and the visual information in a graphical area. The user can scroll the analysis result text, point to chart elements, and view tooltips or highlights based on the maintained correspondence.

The user may input an additional prompt sentence to refine the analysis. The user may, for example, enter “Focus only on the last two quarters and compare our growth to the top three competitors,” “Identify any anomalies in the last 12 months and explain potential business reasons behind them,” or “Segment customers by purchase frequency and value, and recommend marketing strategies for each segment.” The terminal sends the additional prompt sentence to the server. The server does not repeat the entire preprocessing of the raw data.

Instead, the server reuses the existing analysis dataset and recomputes or adjusts the summary information according to the new prompt. The server again constructs input information for the generative AI model and obtains updated analysis result text. The server updates or regenerates visual information as needed, while maintaining or updating correspondence information. The server sends updated response information to the terminal, thereby implementing iterative, context-preserving analysis without reloading or reformatting the raw analysis target information.

In another embodiment, the server locally hosts the generative AI model on a graphics processing unit. The server stores the parameters of the transformer model in the main memory of the graphics processing unit and uses a deep learning framework to execute matrix multiplications and attention computations in parallel. The server may fine-tune the model using domain-specific datasets that include pairs of summary information and expert-generated analyses. During training, the server computes a loss function, such as cross-entropy between the predicted token distribution and ground-truth tokens, and the server updates the model parameters by backpropagation and a gradient-based optimizer. The server may also employ data augmentation techniques, such as perturbing numeric values or paraphrasing textual descriptions, to improve the robustness of the model.

In another embodiment, the server uses a modular neural network architecture, in which a first model performs classification of the prompt sentence into analysis types, a second model generates structured analysis plans that specify which indices and time ranges should be included in the summary information, and a third generative AI model produces the final analysis result text. This modular structure reduces the complexity of each individual model and allows the server to cache intermediate representations such as analysis plans, which can be reused across multiple prompt sentences for the same dataset. This architecture improves computational efficiency and reduces latency, thereby providing a technical advantage over systems that re-run a single large model with raw data for every user query.

By structuring the processing pipeline in this manner, the server improves computer technology in several ways. The server reduces the size of data passed to the generative AI model by converting the analysis dataset into compact, prompt-aware summary information, which significantly reduces memory usage and communication overhead between the server and the model execution environment. The server reduces redundant computations by reusing the analysis dataset across multiple prompt sentences and by selectively re-aggregating only those indices and time ranges that are affected by the new prompt. This leads to faster response times and improved throughput when multiple users access the system.

In addition, the server increases the reliability and accuracy of the analysis by systematically removing abnormal values and normalizing formats before analysis, and by performing classification and clustering based on machine-readable feature vectors rather than ad hoc manual grouping. The server enforces non-conventional rules that differ from human manual analysis, such as automatically selecting aggregation granularities based on statistical variance or automatically choosing clustering parameters based on silhouette scores. These algorithmic decisions are difficult to perform consistently and quickly by a human analyst but can be executed efficiently and reproducibly by the server.

The explicit maintenance of correspondence information between description units and indices enables technical enhancements in user interaction. The terminal can render interactive displays where selection of a sentence triggers highlighting of associated graphical elements, and where selection of a chart element triggers scrolling to the corresponding sentence. This synchronized behavior is achieved by machine-level identifiers and mapping tables stored by the server, rather than by manual alignment. This improves navigation within large analytical reports and reduces the cognitive load required for a user to understand complex visualizations.

Because the server configures the summarization and visualization operations in response to structured interpretations of the prompt sentence, the system performs adaptive data processing that is not a mere automation of human reasoning. The server dynamically modifies the data path, including which tables, views, and indices are accessed, based on analysis types extracted from the natural-language input. This results in a customized computational pipeline that would be impractical to configure manually for each query. The technical effect is improved utilization of processing resources, improved scalability, and more stable quality of the analysis output.

Various modifications and alternative embodiments are possible. In one variant, the server may employ a distributed processing framework to handle very large analysis datasets by distributing preprocessing and aggregation tasks across multiple computing nodes. In another variant, the server may store summary information in a specialized in-memory database to accelerate retrieval and recomputation in iterative analysis scenarios. In yet another variant, the terminal may execute a portion of the visualization generation logic locally, while the server only transmits a compact visualization specification. These and other variations may be combined while still conforming to the claimed configuration in which the server preprocesses analysis target information into an analysis dataset, generates prompt-aware summary information, constructs input information for a generative AI model, generates analysis result text and visual information, maintains associations between them, and iteratively updates the analysis in response to additional prompt sentences provided by the user.

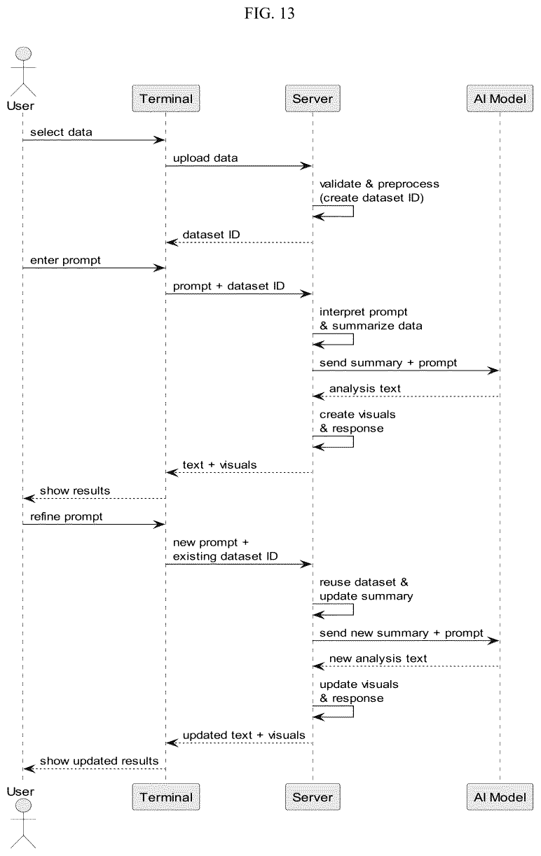

The following describes the processing flow using FIG. 13.

### Step 1:

The user prepares analysis target information. The user selects one or more data files, such as a comma-separated values file, a spreadsheet file, or a structured text file, and the user operates the terminal to choose the files through a graphical user interface. The input of this step is raw data stored in a local storage of the terminal or an accessible storage service. The output of this step is a selected file handle or memory buffer that represents the chosen analysis target information.

### Step 2:

The terminal reads the selected analysis target information. The terminal loads the file contents into memory, parses basic metadata such as file name, size, and apparent format, and the terminal prepares a request payload for transmission to the server. The input of this step is the file handle or memory buffer from Step 1. The terminal performs a data reading operation that converts the file into a binary or text stream suitable for network transmission. The output of this step is an upload request including the analysis target information and associated metadata.

### Step 3:

The terminal transmits the analysis target information to the server. The terminal sends an HTTP request over a communication network to a server endpoint dedicated to data upload. The input of this step is the upload request payload created in Step 2. The terminal may compress the payload or segment it into chunks depending on communication settings. The output of this step is a received network stream at the server side containing the raw analysis target information.

### Step 4:

The server receives and stores the raw analysis target information. The server accepts the network stream, reconstructs the original file content, and writes it to a temporary storage area in a non-volatile storage device. The input of this step is the network stream from Step 3. The server performs a data reception operation and a write operation to persistent storage. The output of this step is a stored raw data file and an internal identifier that references the stored file.

### Step 5:

The server validates the format and structure of the analysis target information. The server uses a data parsing module to open the stored file, determine whether it conforms to an expected format such as a delimited text table, and check for the presence of required columns or fields. The input of this step is the stored raw data file from Step 4. The server performs parsing and schema inspection operations, such as reading the header row, inferring data types, and detecting structural inconsistencies. The output of this step is either an error description or a preliminary in-memory representation of the dataset with inferred schema information.

### Step 6:

The server preprocesses the analysis target information into an analysis dataset. The server takes the preliminary dataset and applies operations including completion of missing values, exclusion of abnormal values, normalization of formats, and derivation of attributes. The input of this step is the in-memory dataset and schema from Step 5. The server computes statistics for each column, fills missing values according to chosen imputation rules, removes or marks records with values outside predefined thresholds, standardizes date and numeric formats, and computes derived fields such as time indices and ratio metrics. The output of this step is a cleaned and enriched analysis dataset stored in memory or a structured data store, together with a dataset identifier.

### Step 7:

The user provides a prompt sentence describing an analysis objective. The user views a prompt input field on the terminal, types a natural-language instruction such as “Analyze the recent sales performance of each competitor, highlight major trends, and propose three strategic actions for the next quarter,” and confirms the input. The input of this step is the user's intent expressed verbally and captured through the terminal interface. The terminal converts the typed characters into a text string. The output of this step is a prompt sentence string stored in the terminal's memory.

### Step 8:

The terminal transmits the prompt sentence and the dataset identifier to the server. The terminal constructs an HTTP request that includes the prompt sentence and the identifier returned for the analysis dataset. The input of this step is the prompt sentence from Step 7 and the dataset identifier previously obtained from the server. The terminal formats these elements into a structured request body. The output of this step is a network message delivered to the server that associates the user's analysis request with a particular dataset.

### Step 9:

The server interprets the prompt sentence and determines an analysis type. The server receives the network message, extracts the prompt sentence and the dataset identifier, and passes the prompt sentence to a natural language processing module. The input of this step is the prompt sentence and the dataset identifier from Step 8. The server tokenizes the prompt sentence, applies a classifier or rule set to detect keywords related to trend analysis, segmentation, anomaly detection, forecasting, or comparison, and assigns one or more analysis-type labels. The output of this step is a classified analysis request that includes the dataset identifier and the inferred analysis type.

### Step 10:

The server selects indices, periods, and classification axes based on the analysis type. The server consults a configuration that maps analysis types to relevant metrics and grouping dimensions. The input of this step is the classified analysis request from Step 9 and metadata for the analysis dataset from Step 6. The server evaluates which columns of the dataset can serve as time attributes, categories, or measures, and chooses a subset matching the analysis type. For example, for trend analysis the server chooses a time index and a main metric; for segmentation the server chooses feature columns and a segment label. The output of this step is a selection plan that lists indices to compute, time ranges or granularities to use, and classification axes for grouping.

### Step 11:

The server generates summary information from the analysis dataset. The server applies aggregation and statistical functions to the dataset according to the selection plan. The input of this step is the analysis dataset from Step 6 and the selection plan from Step 10. The server performs data grouping by time or category, computes sums, averages, counts, variances, or other statistics, and may run clustering or classification algorithms to segment entities. The server organizes the results into a structured summary representation, such as tables keyed by time or category and cluster descriptors. The output of this step is summary information that captures the essential patterns of the dataset relevant to the prompt sentence.

### Step 12:

The server constructs input information for the generative AI model. The server combines the summary information with the prompt sentence and optional system-level instructions. The input of this step is the summary information from Step 11 and the original prompt sentence from Step 8. The server serializes the summary into text or structured tokens, concatenates it with the prompt sentence and an instruction describing the expected output style, and arranges these elements into a sequence of messages compatible with the generative AI model interface. The output of this step is a model input structure ready to be transmitted to the generative AI model.

### Step 13:

The server executes the generative AI model to obtain analysis result text. The server forwards the model input structure to a generative AI model running locally or accessible through an application programming interface. The input of this step is the model input structure from Step 12. The generative AI model applies a transformer-based neural network, computes attention-based transformations of the token sequences, and produces probability distributions over output tokens. The server decodes the output tokens into a natural-language analysis. The output of this step is analysis result text that includes explanations, insights, and recommendations aligned with the prompt sentence and the summary information.

### Step 14:

The server identifies description units and links them to indices. The server divides the analysis result text into description units such as sentences or list items. The input of this step is the analysis result text from Step 13 and the summary information from Step 11. The server searches for references in each description unit to specific indices or groups, for example by matching index names or numeric values, or by using tags supplied by the generative AI model. The server then writes entries into a correspondence table that pairs identifiers for description units with identifiers for indices. The output of this step is a mapping structure that records which parts of the text refer to which metrics.

### Step 15:

The server generates visual information based on the analysis dataset and the summary information. The server chooses visualization types according to the selected indices and classification axes. The input of this step is the summary information and the mapping structure from Step 14. The server uses a visualization library to create charts such as line graphs for time series, bar charts for category comparisons, or scatter plots for value distributions. The server embeds identifiers for each graphical element, such as a bar or a line segment, corresponding to the indices represented. The output of this step is a set of visual information objects, each including a graphical representation and associated identifiers.

### Step 16:

The server assembles response information for the terminal. The server packages the analysis result text, the visual information objects, and correspondence metadata into a structured response body. The input of this step is the analysis result text from Step 13 and the visual information objects from Step 15. The server may include additional metadata such as the analysis type, data range, and model parameters used. The output of this step is a response message ready to be transmitted to the terminal.

### Step 17:

The server transmits the response information to the terminal. The server sends an HTTP response containing the assembled response body over the communication network. The input of this step is the structured response message from Step 16. The server may apply compression or streaming techniques to optimize bandwidth. The output of this step is a network stream that delivers the analysis result text, visual information, and correspondence metadata to the terminal.

### Step 18:

The terminal receives and renders the analysis result text and visual information. The terminal parses the received response body and updates the user interface accordingly. The input of this step is the network stream from Step 17. The terminal places the analysis result text into a textual display area, renders the charts in graphical components, and may implement interactions that use the correspondence metadata to highlight related text and graphics. The output of this step is a displayed analysis interface visible and operable by the user.

### Step 19:

The user evaluates the displayed analysis and optionally issues an additional prompt sentence. The user reads the analysis result text, inspects the charts, and decides whether further refinement is needed. The input of this step is the displayed analysis on the terminal. The user may type a follow-up prompt sentence, such as “Focus only on the last two quarters and compare our growth to the top three competitors,” or “Identify any anomalies in the last 12 months and explain potential business reasons behind them.” The output of this step is a new prompt sentence captured by the terminal.

### Step 20:

The terminal sends the additional prompt sentence and a reference to the existing analysis dataset to the server. The terminal constructs a new analysis request that includes the additional prompt sentence and the dataset identifier used previously. The input of this step is the new prompt sentence from Step 19 and the stored dataset identifier. The terminal formats and transmits an HTTP request similar to the initial analysis request. The output of this step is a network message that instructs the server to perform iterative analysis using the existing analysis dataset.

### Step 21:

The server reuses the analysis dataset and updates the summary information and analysis result text. The server receives the new prompt sentence and the dataset identifier, retrieves the analysis dataset without re-running full preprocessing, and repeats the selection, aggregation, and model execution steps with parameters adapted to the new prompt. The input of this step is the analysis dataset from Step 6 and the additional prompt sentence from Step 20. The server recomputes or filters summary information, constructs new input information for the generative AI model, obtains new analysis result text, regenerates or updates visual information, and refreshes the correspondence mappings. The output of this step is updated analysis result text and updated visual information, which the server sends back to the terminal through a process analogous to Steps 16 and 17.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented data analysis systems typically require a human operator to manually design analysis workflows, construct queries, select algorithms, and craft model inputs for each new business question. Even when such systems incorporate a generative artificial-intelligence model, the model is usually invoked in an ad-hoc manner: a user manually writes a prompt, pastes partial data or summaries into the prompt, and then post-processes the model's output. As a result, the overall pipeline from heterogeneous raw data to usable decision support remains fragmented, labor-intensive, and highly dependent on the skill of the individual user in both data science and prompt engineering.

Furthermore, existing systems generally treat the generative artificial-intelligence model as a passive text generator attached to a separate analytics engine. These systems do not automatically transform a natural-language analysis instruction into a structured representation of an analysis task, do not systematically derive a task-specific prompt sentence from machine-readable analysis results, and do not tightly couple statistical or machine-learning outputs with the generative model's narrative reasoning. This loose coupling leads to inefficiencies, inconsistencies between numeric results and textual explanations, and limited reproducibility of the analytical process.

In addition, many systems ignore dynamic user context, in particular the emotional state of the user interacting with the system. Conventional interfaces present identical explanations, visualization density, and recommendation styles regardless of whether the user is confused, anxious, or highly engaged. As a consequence, users may be overwhelmed by technical details when they require simplified guidance, or may be under-informed when they are ready to explore aggressive strategies. The computer system therefore fails to adapt its internal prompt construction and output presentation to the user's real-time cognitive and emotional needs.

From a computer-technology perspective, there is a need for a system architecture and processing method that: (i) automatically parses natural-language analysis instructions into a structured task definition; (ii) unifies and preprocesses heterogeneous data sources into machine-interpretable tabular and textual forms; (iii) performs statistical and machine-learning analysis to generate intermediate numeric and semantic features; (iv) constructs a task-specific, context-aware prompt sentence that encapsulates these features for a generative artificial-intelligence model; and (v) adjusts both prompt content and output presentation using emotion-recognition results derived from user interaction signals. Without such an integrated mechanism, computer-implemented decision support remains brittle, non-scalable, and inefficient, and cannot fully exploit the capabilities of generative models as part of a robust, end-to-end analytical pipeline.

Accordingly, an object of the present invention is to improve computer-implemented data analysis and decision support by providing a processor-controlled system that automatically orchestrates data acquisition, preprocessing, analysis, prompt generation, generative-model invocation, and visualization, while dynamically adapting both the internal prompt structure and the external presentation to a recognized emotional state of the user.

The specific processing by the specific processing unit 290 of the data processing device 12 in Application Example 2 is realized by the following means.

The present invention provides a server comprising a processor configured to provide, via a terminal, an information input/output interface for receiving an analysis instruction expressed in natural language from a user, to extract, from a content of the analysis instruction, a type of analysis task, an analysis target period, and an output format and to structure the extracted items as an internal representation, to acquire, from an external storage apparatus or a communication network, public information resources, paid information resources, and user-specific information resources and to store the acquired information as tabular information and character-string information while unifying a format thereof, to perform preprocessing on the tabular information by executing at least missing-value completion, normalization, data type conversion, combination, and removal of unnecessary information so as to convert the tabular information into a format suitable for analysis, to perform preprocessing on the character-string information by executing at least tokenization, normalization, and removal of sensitive information so as to convert the character-string information into a format suitable for analysis, to execute, on the basis of the structured analysis task and the preprocessed tabular information, statistical processing or machine-learning processing to calculate prediction values, index values, and aggregated values, to execute, on the character-string information, emotion analysis processing or topic extraction processing to calculate emotion index values or topic groups, to generate, on the basis of operation-history information transmitted from the terminal and character-string information input by the user, emotion state information indicating an emotion state of the user by performing emotion-recognition processing and to hold the emotion state information as session information, to generate data summary information by summarizing the analysis task, the preprocessed information, the prediction values, the index values, the aggregated values, the emotion index values, and the topic groups and by listing the summarized items, to construct, on the basis of the data summary information, the analysis instruction, and the emotion state information, a prompt sentence that instructs a generative artificial-intelligence model regarding contents of analysis and explanation and regarding an output format and to generate prompt data including the prompt sentence, to input the prompt data to the generative artificial-intelligence model and to cause the generative artificial-intelligence model to generate a text output including an interpretation of the data summary information, insight, meaning attribution, and explanation relating to strategy formulation, to generate, on the basis of the prediction values, the index values, the aggregated values, and the emotion index values, graphic information and numerical information indicating at least one of temporal change, distribution, and comparison relationships by using data-visualization technology, to generate presentation-control information for adjusting, in accordance with the emotion state information, at least one of a detail level, emphasis portions, and a presentation order of the text output and the graphic information, and to transmit, to the terminal, a message including the text output, the graphic information, the numerical information, and the presentation-control information. This enables the computer-implemented analysis pipeline to automatically transform natural-language instructions and heterogeneous data into emotion-adaptive prompts for a generative artificial-intelligence model, to obtain consistent narrative and numerical results, and to present those results in a dynamically tailored manner that improves usability, reduces user burden in designing prompts and workflows, and enhances the technical efficiency and effectiveness of decision support processing performed by the server.

The term “analysis instruction” refers to a natural-language input provided by a user that specifies at least an analysis objective, a target data scope, or a desired output format for a computer-implemented analysis process.

The term “terminal” refers to an information processing apparatus, such as a computing device with a user interface and communication capability, that allows a user to input instructions, transmit data to a server, and receive and display results from the server.

The term “information input/output interface” refers to a logical or physical component, implemented for example as a graphical user interface or an application programming interface, through which a user inputs data or instructions and through which a server outputs analysis results.

The term “analysis task” refers to a structured representation of an operation to be performed on data, including at least a task category such as forecasting, classification, clustering, or trend analysis, and associated parameters.

The term “analysis target period” refers to a time interval designated for analysis or prediction, such as a past period to be examined or a future period to be forecast.

The term “output format” refers to a specification of how analysis results are to be presented, including at least text summaries, graphical visualizations, numerical tables, or combinations thereof.

The term “internal representation” refers to a data structure used within a computer system to encode elements derived from a user instruction, such as task type, time range, and output preferences, in a machine-interpretable form.

The term “public information resources” refers to data sources that are generally accessible without individualized licensing, such as open datasets, public web content, or freely available reports.

The term “paid information resources” refers to data sources that are accessible only upon payment of a fee or under a commercial license agreement, such as subscription-based market data or licensed research reports.

The term “user-specific information resources” refers to data sources that are owned, controlled, or created by a particular user or organization, including proprietary logs, internal databases, or confidential datasets.

The term “external storage apparatus” refers to a storage system accessible via a communication interface, such as a remote database, a file server, or a cloud storage service.

The term “communication network” refers to a wired or wireless infrastructure that enables data exchange between a terminal, a server, and other resources, including local area networks and wide area networks.

The term “tabular information” refers to data organized in a structured format comprising records and fields, such as rows and columns of a table or a data frame.

The term “character-string information” refers to data expressed as sequences of characters, including textual documents, messages, or other natural-language content.

The term “missing-value completion” refers to a preprocessing operation that replaces absent or undefined data entries with substituted values according to a specified rule, such as mean, median, or model-based estimates.

The term “normalization” refers to a preprocessing operation that adjusts numeric or categorical data into a standardized range or representation to facilitate analysis or comparison.

The term “data type conversion” refers to a preprocessing operation that changes a representation type of data elements, such as converting a string to a numeric value or a timestamp.

The term “combination” refers to a preprocessing operation that joins or merges multiple datasets or tables based on one or more keys or relationships to form integrated tabular information.

The term “removal of unnecessary information” refers to a preprocessing operation that deletes data elements, fields, or records that are deemed irrelevant, redundant, or inconsistent with the analysis objective.

The term “tokenization” refers to a preprocessing operation that segments character-string information into units such as words, subwords, or symbols suitable for natural-language processing.

The term “removal of sensitive information” refers to a preprocessing operation that detects and masks or deletes data elements containing personal, confidential, or otherwise sensitive content.

The term “statistical processing” refers to a computational operation that derives descriptive or inferential measures from data, including estimation, hypothesis testing, or regression analysis.

The term “machine-learning processing” refers to a computational operation in which a model is trained or applied to data to perform tasks such as prediction, classification, clustering, or recommendation.

The term “prediction values” refers to output data generated by a forecasting or predictive model, representing estimated future states or outcomes.

The term “index values” refers to computed metrics that summarize or quantify aspects of data, such as ratios, scores, or composite indicators.

The term “aggregated values” refers to numeric results obtained by applying aggregation functions, such as sums, averages, counts, or group-wise statistics, over sets of data records.

The term “emotion analysis processing” refers to a computational operation that infers emotional attributes, such as positivity, negativity, or specific emotion categories, from character-string information.

The term “topic extraction processing” refers to a computational operation that identifies themes, subjects, or latent topics represented in character-string information.

The term “emotion index values” refers to numeric indicators that quantify emotional attributes, such as intensity or probability of specific emotions, derived from emotion analysis processing.

The term “topic groups” refers to clusters or sets of textual items that share similar semantic themes as identified by topic extraction processing.

The term “operation-history information” refers to data that records interactions of a user with a system, including at least input events, navigation actions, timing information, and interface usage patterns.

The term “emotion-recognition processing” refers to a computational operation that estimates an emotional state of a user based on at least one of operation-history information and user-provided textual content.

The term “emotion state information” refers to data representing an inferred emotional condition of a user, including types and intensities of emotions such as anxiety, confusion, excitement, or expectation.

The term “session information” refers to data associated with an ongoing interaction between a user and a system, maintained for a duration and used to preserve context across multiple requests or responses.

The term “data summary information” refers to a compact representation that condenses analysis tasks, preprocessed data features, prediction values, index values, aggregated values, emotion index values, and topic groups into a structured, machine-readable form.

The term “prompt sentence” refers to a natural-language or structured instruction string that directs a generative artificial-intelligence model to perform specific analysis, explanation, or formatting operations.

The term “prompt data” refers to information transmitted to a generative artificial-intelligence model, including at least one prompt sentence and optionally associated metadata or context.

The term “generative artificial-intelligence model” refers to a computational model trained on data to generate new content, such as natural-language text, in response to given inputs or instructions.

The term “text output” refers to a set of character-string data produced by a generative artificial-intelligence model or by another processing component, including interpretations, explanations, or recommendations.

The term “meaning attribution” refers to a process or result in which data or findings are assigned contextual or semantic significance beyond raw numeric values.

The term “strategy formulation” refers to the generation of planned actions or policies, based on analytical results, aimed at achieving specified objectives in domains such as business or operations.

The term “graphic information” refers to data defining visual representations, such as charts, graphs, or diagrams, that depict at least one of temporal trends, distributions, or comparisons.

The term “numerical information” refers to data expressed as numbers, including measures, statistics, and computed indicators used in analysis or reporting.

The term “data-visualization technology” refers to techniques and tools for converting numerical or categorical data into visual forms that facilitate human interpretation.

The term “temporal change” refers to variation of a variable or measure over time, often represented as a sequence or time series.

The term “distribution” refers to the spread or frequency pattern of values within a dataset or variable.

The term “comparison relationships” refers to relative differences or ratios between values, groups, or time periods within or across datasets.

The term “presentation-control information” refers to data that specifies how analysis results, including text and graphics, are to be arranged, emphasized, filtered, or detailed when displayed to a user.

The term “detail level” refers to a degree of granularity or amount of information included in a presentation, ranging from high-level summaries to fine-grained technical details.

The term “emphasis portions” refers to selected parts of content that are visually or structurally highlighted to draw user attention, such as key metrics, warnings, or recommendations.

The term “presentation order” refers to a sequence in which different elements of analysis results, such as summaries, details, and visuals, are shown to a user.

The term “message” refers to a data unit transmitted from a server to a terminal that includes at least text output, graphic information, numerical information, and presentation-control information.

In one embodiment, a server, a terminal, and a user cooperate to implement the invention. The server includes at least one processor, a memory, a non-volatile storage apparatus, and a network interface. The terminal includes a processor, a display, an input device, and a communication interface, and may be realized as a smartphone, a tablet, or a personal computer. The user operates the terminal to provide natural-language analysis instructions and to review analysis results returned from the server.

The server executes an application program stored in the memory. The application program is implemented, for example, using an operating system, a web server, an application framework, and a data-processing stack including an interpreter for a high-level programming language such as Python, a data-analysis library such as a tabular-data library, a machine-learning library such as a general-purpose machine-learning library, a natural-language-processing library such as a transformer-based library, and a visualization library such as a plotting library. The server may further access one or more database management systems, such as a relational database, for storing user data, uploaded datasets, analysis logs, and model metadata.

The server exposes a network-accessible user interface. The server transmits a web page implemented using markup language and scripting language to the terminal. The terminal renders the web page and displays an input field for a natural-language analysis instruction, file-upload controls for data files such as comma-separated-value files or spreadsheet files, and one or more panels for presenting text output and graphical information. The user enters an analysis instruction such as:

“Predict how competitor prices will change over the next three months and show the results in a graph.” or

“Analyze competitor movements and customer preference shifts and propose a sales strategy for the next quarter.”

The terminal transmits the analysis instruction and any uploaded data files to the server via a communication protocol such as HTTPS.

The server receives the analysis instruction as character-string information and constructs an internal representation of an analysis task. The server applies a natural-language-processing component implemented using a transformer-based encoder to the analysis instruction. The server uses the encoder to compute an embedding vector sequence from tokenized input text.

The server applies a classification layer, such as a fully connected neural layer with a softmax activation, on top of the encoder output to predict a task category label (for example, forecasting, campaign-effect analysis, review-analysis, or market-trend analysis), a temporal horizon (for example, three months, one quarter, or one year), and an output-format preference (for example, textual summary, graph, or table). The server stores these elements in the memory in a structured data structure such as a dictionary or a record object. This structured representation allows subsequent modules to select algorithms and visualization types without re-parsing the natural-language instruction, which improves computational efficiency and reduces parsing errors compared to purely rule-based keyword extraction.

The server processes heterogeneous data sources. The server acquires public information resources from external web services or open data repositories via an HTTP client library, acquires paid information resources from subscription-based application-programming interfaces using authenticated requests, and acquires user-specific information resources from stored internal logs and uploaded files using database queries or file-system access. The server converts each acquired dataset into a tabular data structure using a tabular-data library.

The server standardizes column names and data types based on predefined schema dictionaries and on metadata embedded in the datasets. For example, the server converts date columns into a timestamp type, converts price and quantity columns into numeric types, and normalizes categorical labels such as product categories or regions into canonical codes.

The server performs preprocessing on tabular information using a combination of deterministic rules and machine-learning-based estimators. The server uses imputation methods from a machine-learning library to fill missing values, such as mean or median imputation for continuous variables and most-frequent-value imputation for categorical variables. The server applies normalization methods, such as min-max scaling or z-score standardization, to numerical features to improve the conditioning of subsequent regression or classification models. The server performs data type conversion to ensure compatibility with model expectations, for example converting integer encodings to one-hot feature vectors or embedding indices. The server executes combination operations by joining tables on shared keys such as product identifiers and timestamps, using join algorithms that are optimized for in-memory columnar structures. By performing these structured preprocessing operations inside the server, the system reduces the risk of inconsistent data preparation that might occur if each user manually manipulated spreadsheets, and thereby improves reproducibility and model accuracy.

The server processes character-string information such as customer reviews, product descriptions, survey responses, or free-form notes. The server uses a tokenizer associated with a transformer-based language model to segment the text into subword tokens. The server normalizes text by lowercasing, removing control characters, and applying Unicode normalization. The server executes a sensitive-information-removal module that uses a named-entity-recognition model implemented as a neural sequence tagging architecture or as a conditional random field on top of a contextual encoder, to detect personal names, contact information, and other sensitive terms; the server masks or deletes these tokens before any further processing. This structured removal of sensitive elements reduces the risk of leaking personal information to external generative AI endpoints and improves compliance with privacy constraints.

The server executes statistical and machine-learning analysis based on the internal representation of the analysis task. For forecasting tasks, the server constructs feature vectors from preprocessed tabular information. The server includes time-lag features, rolling aggregates, categorical encodings, and exogenous indicators such as campaign flags. The server trains a regression model, which may be an ensemble method or a linear model, by minimizing a loss function such as mean-squared error using gradient-based or closed-form optimization procedures. The server may alternatively employ a time-series neural network, such as a recurrent neural network or a temporal convolutional network, trained offline on historical datasets and stored in the server's model registry. The server computes prediction values for future time periods by applying the trained model to constructed future feature matrices.

For classification or clustering tasks, the server uses algorithms from the machine-learning library. The server may use logistic regression, support vector machines, decision-tree ensembles, or k-means clustering, depending on the task type encoded in the internal representation. The server computes index values such as predicted probabilities, cluster assignments, or segment scores, and computes aggregated values such as group-wise means, growth rates, or distribution summaries. The use of algorithm selection based on a structured task representation enables the server to avoid inefficient generic heuristics, resulting in improved computation time and predictive performance.

The server performs emotion analysis processing and topic extraction processing on character-string information. The server uses a transformer-based classifier fine-tuned on labeled emotion datasets. The classifier architecture consists of an encoder generating contextual token embeddings, a pooling operation generating a sentence representation, and a dense classification layer outputting emotion logits which are converted to probabilities via a softmax function. The server computes emotion index values by mapping these probabilities into scalar scores for emotions such as positive, negative, excitement, or anxiety. The server also applies a topic extraction model, which may be a neural topic model or an embedding-plus-clustering pipeline, to group reviews or comments into topic groups representing themes such as price, quality, or service. These computed values and topic groups serve as features for subsequent prompt construction, enabling the generative AI model to reason over emotion and topic summaries without directly inspecting large volumes of raw text.

The server recognizes a user's emotion state from operation-history information and user-input text. The terminal transmits interaction logs, including timestamps of page loads, durations of viewing particular sections, scroll depth, click counts, and patterns of cursor movements, to the server. The server encodes these sequences into numeric feature vectors using time-series encoding techniques. The server concatenates or otherwise fuses these vectors with embeddings of recent user-input text. The server inputs the combined representation into an emotion-recognition model, which may be a neural network consisting of temporal processing layers and dense output layers. The server outputs emotion state information such as a label (for example, anxious, confused, neutral, excited) and associated confidence scores. The server stores this emotion state information as session information associated with the user's current analysis session. By maintaining this session-level context, the server can adapt its behavior over multiple requests without repeatedly re-estimating the full emotional history, thereby reducing computation and network load.

The server generates data summary information that condenses the analysis context into a structured form. The server extracts key prediction values such as forecasted prices or expected conversion rates at specified future times, key index values such as growth percentages, key aggregated values such as average revenue per segment, emotion index values summarized across time or product groups, and representative topic labels. The server arranges these elements into a hierarchical data structure comprising sections such as “overall trends,” “segment breakdowns,” and “emotion and sentiment metrics.” This structuring reduces the size and complexity of information to be passed to a generative AI model and facilitates deterministic mapping between numeric results and textual explanations.

The server constructs a prompt sentence for a generative AI model using the data summary information, the original analysis instruction, and the emotion state information. The server selects a prompt template from a plurality of stored templates based on the analysis task type and the emotion state. Each template includes predefined textual scaffolding and placeholders for data summary elements and user instructions. For example, for a forecast scenario with an anxious user, the server may select a template containing instructions to provide step-by-step guidance and to use simple language. The server fills the placeholders with the actual numeric and textual summaries. A concrete example of such a prompt sentence is:

“You are an expert pricing analyst for an e-commerce platform. The processed forecast data for the next three months is as follows: competitor A shows an average expected price increase of 5% with moderate volatility, competitor B shows a stable price with less than 1% variation, and competitor C shows a potential price decrease of 3% in the low-price segment. The user's original request is: ‘Predict how competitor prices will change over the next three months and show the results in a graph.’ The user currently appears anxious and may prefer clear, step-by-step guidance. Based on this information, explain the forecasted competitor price trends in simple terms, highlight key risks and opportunities, and provide a clear, step-by-step pricing and promotion plan for the next three months. Structure your answer into the following sections: Summary, Details, Recommendations.”

By generating prompt sentences from an explicit template and structured summary, the server reduces randomness and inconsistency in generative outputs that would occur if users manually crafted prompts, thereby improving reliability and repeatability of the generative AI model's behavior.

The server inputs prompt data including the constructed prompt sentence into a generative AI model. The generative AI model may be a transformer-based language model deployed either locally in the server environment or accessible via an external inference service. The model architecture typically consists of multiple self-attention layers, feed-forward layers, and positional encoding components. The server configures model parameters such as maximum output length, sampling temperature, and decoding strategy (for example, beam search or nucleus sampling) according to the task type and emotion state. The server receives a text output from the generative AI model, including an interpretation of the data summary, an insight narrative, meaning attribution for observed patterns, and explanation relating to strategy formulation. Because the inputs to the generative AI model are constrained to structured summaries with known correspondence to numeric features, the server can cross-validate certain parts of the generated text against the underlying data, detect contradictions, and optionally adjust or re-prompt the model, thereby improving accuracy.

The server generates graphic information and numerical information corresponding to the analysis results. The server invokes a plotting library to create charts representing temporal change, distributions, or comparison relationships. For example, the server generates a time-series line chart of predicted competitor prices, a bar chart comparing segment-level growth rates, and a stacked bar chart representing distribution of emotion index values across products. The server precomputes and encodes these graphics as image files or vector graphics descriptions and stores them with associated metadata such as axis labels, legends, and data ranges. The server also assembles numerical information into tables or key-performance-indicator cards for display. By generating these visualizations on the server, the system offloads computation from the terminal and ensures consistent rendering across devices.

The server produces presentation-control information to adapt the presentation of the text output and graphic information based on the emotion state information. For example, when the emotion state indicates anxiety or confusion, the server sets a high detail level and marks certain explanations as mandatory, causing the terminal to expand explanatory sections by default and to emphasize warning messages. When the emotion state indicates excitement or expectation, the server sets a compact detail level and flags opportunity-focused sections for visual emphasis, thereby enabling rapid consumption of high-level strategies. This emotion-adaptive control of both prompt content and presentation constitutes more than mere automation of human explanation; it adjusts internal data flows and interface behavior in response to computed, continuous emotion features, thereby improving comprehension and reducing cognitive overload.

The server transmits a message including the text output, the graphic information, the numerical information, and the presentation-control information to the terminal. The terminal renders the content according to the presentation-control information. The terminal displays different sections of the generative AI model's text output in separate panels, displays charts with tooltips, and arranges tables in a manner consistent with the specified level of detail and emphasis. The user reviews the presented information and may submit additional instructions that refine or modify the analysis task. The server processes subsequent instructions using the same internal representations and stored session context, achieving incremental analyses without re-processing all raw data, which improves processing speed and reduces network traffic.

Because the described system uses structured task extraction, algorithm selection, emotion-aware prompt construction, and emotion-dependent presentation control, the system improves computer technology itself. The system reduces computational waste by avoiding generic, all-purpose models for every query; instead, the server selects and configures specialized models based on explicit task metadata. The system improves prediction and explanation accuracy by limiting generative AI inputs to curated summaries that are aligned with underlying numeric computations. The system reduces latency by caching preprocessed data and by reusing session-level context for multiple requests. The system also reduces communication bandwidth because the terminal does not need to transmit entire datasets repeatedly; instead, the server manages data acquisition and retains preprocessed representations.

In another embodiment, the server employs a locally hosted generative AI model instead of an external service. The server loads model parameters from a model file stored in the non-volatile storage apparatus into memory. The server performs inference using optimized linear-algebra operations that exploit hardware acceleration such as graphics processing units or tensor processing units. The server may quantize model weights or use pruning techniques to reduce computation time and memory usage without substantial loss of output quality. By integrating model optimization techniques with the described data preprocessing and prompt-construction pipeline, the system further decreases response time and improves throughput.

In yet another embodiment, the server uses a different neural architecture for emotion recognition, such as a multimodal network that combines textual embeddings with features derived from pointer movements or keystroke dynamics extracted at the terminal and transmitted as preprocessed events. The server normalizes and encodes these interaction signals as sequences and passes them through a temporal-convolution or recurrent-network layer, enhancing robustness of emotion estimation. The server uses the resulting emotion state information not only for prompt adaptation but also to adjust the timing of automatic refreshes, the density of suggested next actions, or the split between graphical and textual content, thereby improving human-machine interaction at a technical level.

Although the embodiments above focus on electronic commerce analysis, the same system architecture can be applied to other technical domains, such as manufacturing process monitoring, network traffic analysis, or energy-consumption optimization. In such domains, the server acquires sensor readings or log data, performs domain-specific preprocessing and statistical modeling, constructs task-specific prompt sentences describing faults, trends, or optimization opportunities, and uses a generative AI model to generate maintenance instructions, anomaly interpretations, or control recommendations. The server then displays the results on terminals located near machinery or control rooms. Because the system integrates structured analytics and generative explanation with emotion-aware presentation, engineers can more quickly interpret large volumes of technical telemetry, improve system uptime, and reduce diagnosis errors, thereby demonstrating technical improvements beyond abstract information processing.

In all embodiments, the server executes defined data flows and algorithmic steps that differ from conventional manual analysis or simple automation. The server does not merely replace human analysts with generic AI; the server reorganizes the computational pipeline by decomposing natural-language tasks into structured metadata, by binding numeric and semantic features together in data summary structures, by generating prompt sentences from templates conditioned on emotion, and by feeding these prompts to a generative AI model whose behavior is controlled by explicit, machine-computed context. This specific arrangement results in improved processing speed, improved prediction accuracy, reduced misalignment between numeric and textual results, reduced bandwidth consumption, and improved user comprehension, thereby providing concrete technical benefits in the operation of a computer system.

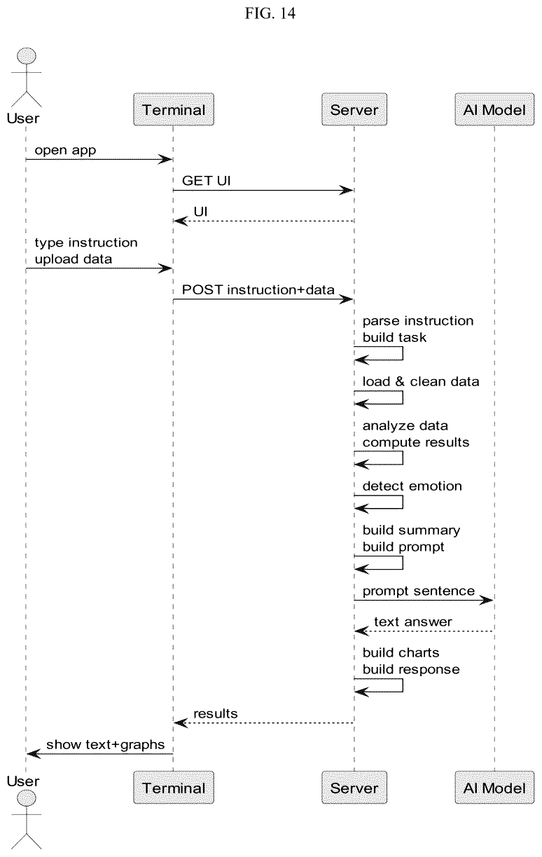

The following describes the processing flow using FIG. 14.

### Step 1:

The user operates the terminal to access the server and open an analysis screen.

The terminal sends an access request to the server as input and receives an HTML/JavaScript page as output.

The server generates the page by loading interface templates from storage and embedding configuration data such as available analysis modes and language settings.

The terminal renders the page on the display, initializes event handlers for text input fields, file-upload controls, and buttons, and waits for user operations.

### Step 2:

The user inputs an analysis instruction in natural language and optionally selects or uploads data files on the terminal.

The terminal receives the analysis instruction text and file contents as input and outputs an HTTP request containing the text and binary data.

The terminal serializes the data into a multipart or JSON payload and transmits the payload to the server through a communication interface.

### Step 3:

The server receives the HTTP request from the terminal.

The server takes the HTTP payload as input and outputs stored raw data objects and a stored analysis instruction.

The server parses headers and body, extracts the analysis instruction string and file streams, writes the uploaded files to a storage apparatus, registers file paths and metadata in a database, and stores the analysis instruction text in association with the user session.

### Step 4:

The server interprets the analysis instruction and constructs an internal representation of an analysis task.

The server uses the analysis instruction string as input and outputs a structured task object that includes a task type, an analysis target period, and an output-format specification.

The server tokenizes the instruction, computes text embeddings with a transformer-based encoder, applies a classification layer to predict a task category and time horizon, and parses explicit phrases indicating output preferences.

The server packs these predicted and parsed elements into a data structure and stores it in memory for subsequent use.

### Step 5:

The server collects and loads heterogeneous data sources required for the analysis.

The server takes the structured task object and data source configuration (public, paid, and user-specific sources) as input and outputs one or more in-memory tabular datasets.

The server issues authenticated HTTP requests to external APIs for public and paid data, reads internal logs and uploaded files from the storage apparatus, and converts all responses and files into tabular objects by invoking a tabular-data library.

The server aligns column names, data types, and time zones based on predefined schemas so that the resulting tables can be jointly processed.

### Step 6:

The server preprocesses tabular information to create analysis-ready numerical datasets.

The server uses the raw tabular datasets as input and outputs cleaned and normalized feature tables.

The server scans each column to detect missing values, applies imputation rules (for example, mean or median for numeric columns, most-frequent value for categorical columns), converts date strings to timestamp types, and standardizes numerical scales using normalization functions such as z-score.

The server joins related tables on keys like product identifiers and timestamps, removes columns flagged as irrelevant by configuration rules, and stores the resulting feature tables in memory.

### Step 7:

The server preprocesses character-string information such as customer reviews or comments.

The server takes raw text fields from the datasets as input and outputs tokenized and sanitized text sequences.

The server applies lowercasing, whitespace cleanup, and Unicode normalization, then invokes a tokenizer associated with a transformer-based model to split the text into subword tokens.

The server detects sensitive entities using a sequence-tagging model or named-entity recognizer, masks or removes tokens containing such entities, and stores the cleaned token sequences and their mapping to original records.

### Step 8:

The server performs core statistical and machine-learning analysis on the preprocessed tabular data.

The server uses the structured task object and cleaned feature tables as input and outputs prediction values, index values, and aggregated values.

The server selects a regression, classification, or clustering algorithm based on the task type, constructs feature matrices and target vectors, trains or applies the chosen model, and computes outputs such as predicted future prices, probabilities, cluster assignments, and group-wise statistics.

The server writes these outputs into new columns of tabular structures and records model performance metrics for potential diagnostics.

### Step 9:

The server analyzes text sentiment and topics from character-string information.

The server takes tokenized text sequences as input and outputs emotion index values and topic groups.

The server runs a transformer-based emotion classifier to compute emotion probabilities for each text item and aggregates these values by product, time period, or campaign into emotion indices.

The server also computes vector embeddings of texts, clusters these embeddings using a clustering algorithm, labels clusters by most representative terms, and stores the resulting topic assignments and labels.

### Step 10:

The terminal records user interaction events and transmits operation-history information to the server.

The terminal uses user actions such as clicks, scrolls, and dwell times as input and outputs encoded interaction logs.

The terminal timestamps each event, aggregates short-interval events into compact records, and periodically sends these records to the server.

### Step 11:

The server recognizes a user emotion state from operation-history information and user-input text.

The server takes interaction logs and recent user-input text as input and outputs emotion state information associated with the current session.

The server converts event sequences into numerical feature vectors, combines them with text embeddings, and applies an emotion-recognition neural network to estimate probabilities for emotion categories such as anxious, confused, neutral, or excited.

The server selects a dominant label, stores the label and associated scores in session storage, and exposes them to other modules for adaptation.

### Step 12:

The server generates data summary information that consolidates analysis outputs.

The server uses the structured task object, prediction values, index values, aggregated values, emotion index values, and topic groups as input and outputs a compact summary structure.

The server selects key metrics based on the task type, for example, top changes, averages, extrema, and representative topics, and arranges them into a hierarchical structure with labeled sections.

The server encodes this structure as a machine-readable object stored in memory for use in prompt construction.

### Step 13:

The server constructs a prompt sentence for a generative AI model.

The server takes the data summary information, the original analysis instruction, and the emotion state information as input and outputs prompt data including a prompt sentence.

The server selects a prompt template based on the task type and emotion label, fills template placeholders with summary metrics and user wording, and appends instructions regarding explanation depth and output structure.

The server builds a complete text instruction such as:

“You are an expert pricing analyst for an e-commerce platform. The processed forecast data for the next three months is as follows: [summary]. The user's original request is: ‘Predict how competitor prices will change over the next three months and show the results in a graph.’ The user currently appears anxious. Based on this information, explain the forecasted competitor price trends in simple terms, highlight key risks and opportunities, and provide a clear, step-by-step pricing and promotion plan. Structure your answer into Summary, Details, and Recommendations.”

### Step 14:

The server invokes a generative AI model using the constructed prompt data.

The server uses the prompt sentence and any associated context as input and outputs a generated text response.

The server sends the prompt to the generative AI model, configures inference parameters such as maximum token count and sampling temperature, and receives a multi-section textual explanation including interpretations, insights, and strategy proposals.

The server optionally checks internal consistency between key numeric statements in the generated text and the stored numeric outputs and, if necessary, adjusts parameters or regenerates selected portions.

### Step 15:

The server generates graphic information and numerical information for visualization.

The server takes prediction values, index values, aggregated values, and emotion index values as input and outputs rendered charts and structured numeric tables.

The server creates time-series plots, bar charts, and other graphs by mapping selected data columns to visual encodings such as axes and colors and renders these graphs into image files or vector formats.

The server assembles tabular summaries and key indicators into data structures ready for display and associates each graphic and table with descriptive metadata.

### Step 16:

The server creates presentation-control information based on the emotion state information.

The server uses the emotion label and scores as input and outputs layout and emphasis parameters.

The server sets flags for detail level, identifies sections of the generated text to highlight or collapse, and prioritizes which charts or tables appear at the top of the display.

The server encodes these settings into a presentation-control object that guides the terminal's rendering behavior.

### Step 17:

The server transmits final results to the terminal.

The server takes the generated text response, graphic information, numerical information, and presentation-control information as input and outputs a response message sent over the network.

The server packages these elements into a structured response, compresses or encodes images as needed, and returns the response to the terminal.

### Step 18:

The terminal renders the results for the user.

The terminal uses the response message as input and outputs visual content on the display.

The terminal parses the response, inserts the text into appropriate panels, draws charts using the received images or graphic descriptions, and constructs tables from the numeric data.

The terminal applies the presentation-control information to determine which sections are expanded, which elements are emphasized, and how navigation controls are arranged.

### Step 19:

The user reviews the presented results and optionally refines the analysis request.

The user observes the generated explanations and visualizations as input and outputs new natural-language instructions or follow-up questions.

The user may, for example, enter a refined request such as “Focus only on the top three competitors and recalculate the strategy,” which the terminal sends back to the server, thereby initiating a new iteration of the described processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

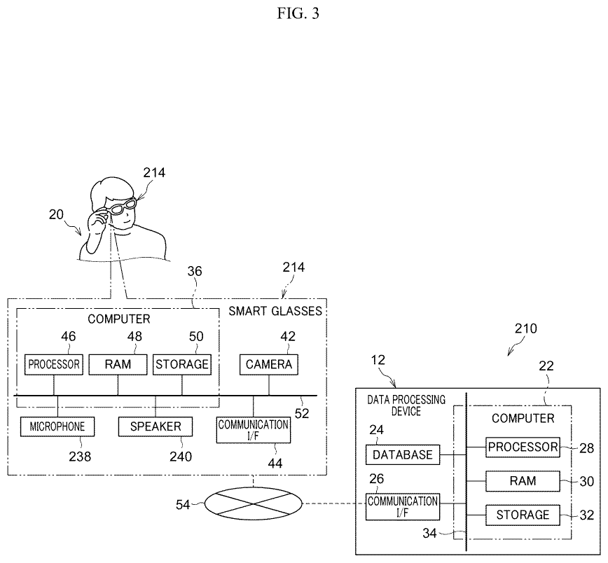

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

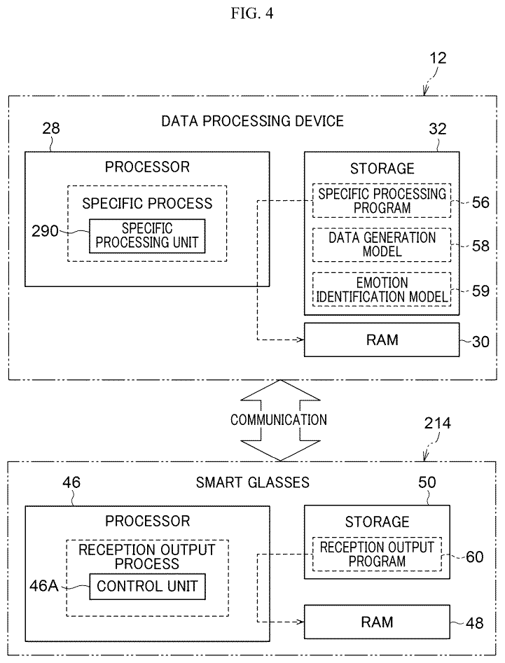

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

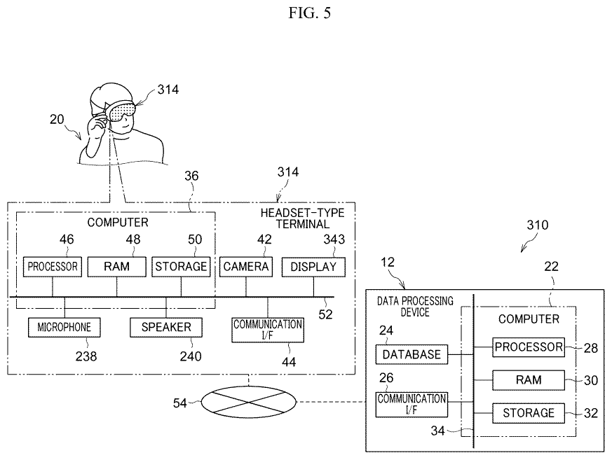

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

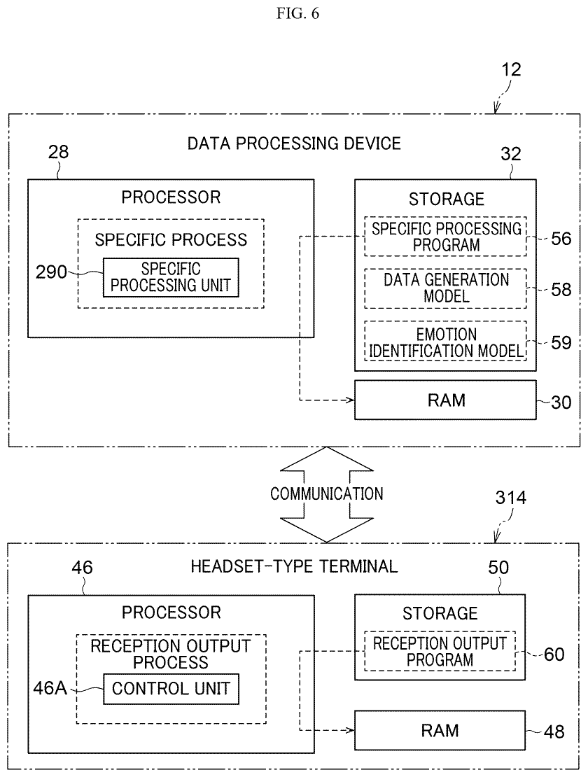

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

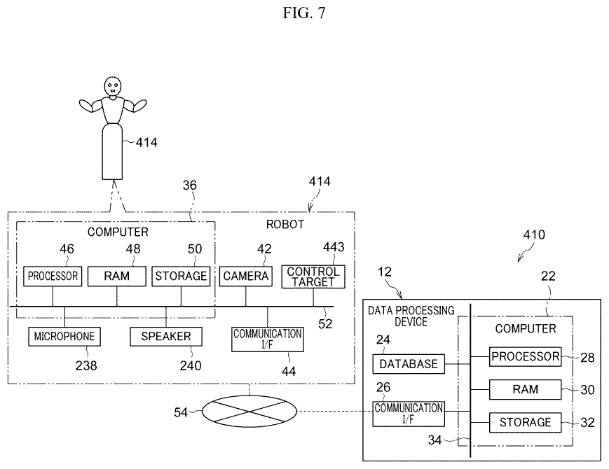

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

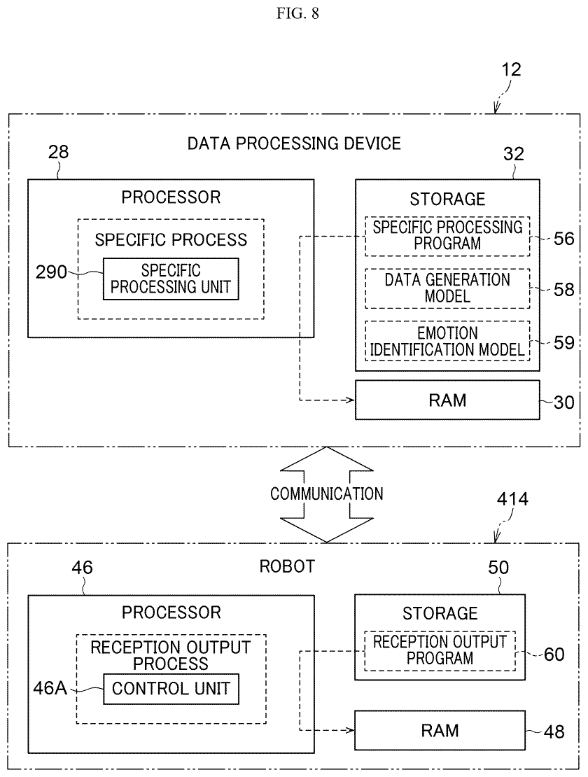

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

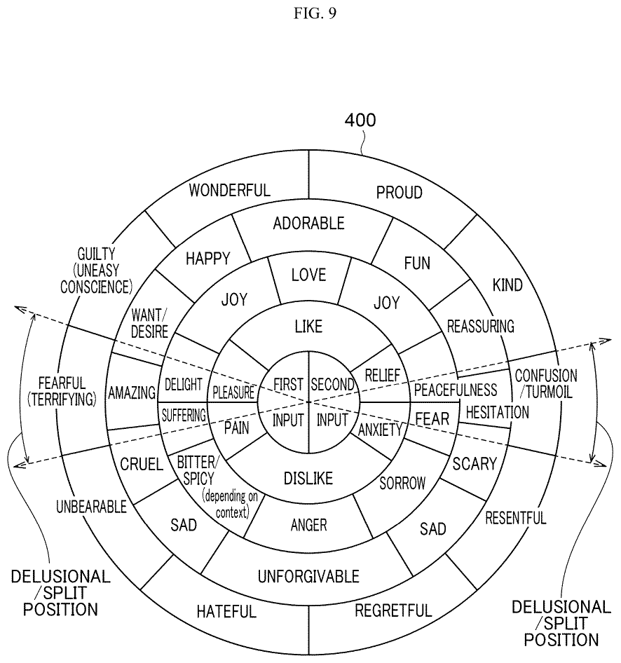

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

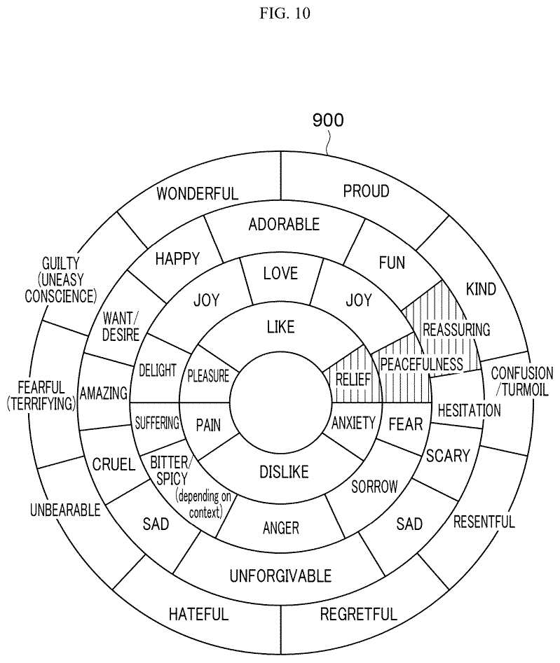

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide an input/output interface for receiving, from a user, an analysis instruction including an analysis purpose, a data range, and a prompt sentence, and for outputting analysis results to a terminal,
acquire, on the basis of the analysis instruction, a plurality of types of data including public information obtained from a plurality of external information sources, paid information provided on a contractual basis, and individual information provided by the user, by using a communication function and a storage function,
perform preprocessing on the acquired plurality of types of data by unifying data formats, processing missing values, converting units, aligning time series, and joining the data based on identification attributes, thereby generating an integrated data set,
calculate, from the integrated data set, predetermined indicators, statistical values, aggregated results, and representative samples, and summarize the calculated results in a text format or a table format, thereby generating data summary information corresponding to an input constraint of a generative AI model,
construct an analysis prompt including the prompt sentence from the user, analysis conditions, the data summary information, and an instruction regarding an output format required from the generative AI model, and generate the analysis prompt as input data for the generative AI model,
transmit the analysis prompt to the generative AI model, receive an analysis result text in natural language from the generative AI model, and generate structured information by extracting summary information, key indicators, recommended actions, and evaluation metrics from the analysis result text,
generate, on the basis of the structured information, at least one piece of graphical information or table-format information that visualizes the analysis result, by using a visualization library to represent at least one of temporal changes, category-wise comparisons, and ratio distributions,
generate report information including the analysis result text, the structured information, and the visualized graphical information, and transmit the report information to the user terminal via the communication function, and
store the report information in a form usable for decision-making by the user, and perform history management by making stored information referable and reusable for iterative analysis processing based on an additional prompt sentence.

### Supplementary 2

The system according to supplementary 1,
wherein the processor is configured to analyze the analysis result text obtained from the generative AI model, divide the analysis result text into a plurality of issues in accordance with analysis viewpoints specified in the prompt sentence, extract quantitative indicators and action proposals for each of the plurality of issues, and reconstruct the analysis result text so as to generate report information including an executable strategy plan.

### Supplementary 3

The system according to supplementary 1,
wherein the processor is configured to refer to the stored report information and past analysis prompts, interpret a new prompt sentence from the user in association with past analysis results, update the analysis prompt to be input to the generative AI model in a stepwise manner, and generate iterative and continuous analysis results in response to additional input from the user.

### Application Example 1

### Supplementary 1

A system comprising a processor,
wherein the processor is configured to
provide an information input/output interface for receiving an analysis instruction expressed in natural language from a user,
obtain a prompt sentence including the analysis instruction and analysis conditions, perform natural language processing on the prompt sentence to extract an analysis target period, an analysis target classification, and an analysis target attribute, and, based on an extraction result, acquire target data from a free information resource, a paid information resource, and a user-specific information resource,
perform preprocessing on the target data by executing, for numerical information, data formatting, missing-value completion, unit standardization, and aggregation computation, and, for character information, morphological analysis, normalization, sentiment classification, and topic classification, thereby generating preprocessed data,
compute, from the preprocessed data, summary statistical values, representative indicators, classification-wise aggregation results, sentiment distributions, and topic distributions, and construct an analysis context in which these elements are structured and combined with the prompt sentence to form a prompt sentence for input to a generative AI model,
input the prompt sentence and the analysis context to an external or internal generative AI model, execute reasoning processing by the generative AI model, and generate, in text format, insight information including tendencies, factors, risks, and improvement measures related to electronic commerce, and strategy proposals including sales measures, pricing measures, promotion measures, and inventory measures,
calculate, based on the preprocessed data and the strategy proposals, visualization information indicating temporal transition information, classification comparison information, and indicator composition ratio information, and forecast indicators, effect indicators, and performance indicators, and structure the visualization information as graph information and numerical information, and
associate text information generated by the generative AI model with the graph information and the numerical information, integrate the associated information as output data, transmit the output data to a user terminal via a communication path, and provide the output data in a format displayable in an interactive manner on the user terminal.

### Supplementary 2

The system according to supplementary 1,
wherein the processor is configured to acquire, based on the analysis target period and the analysis target classification extracted from the prompt sentence, transaction history information, object attribute information, and evaluation information from the user-specific information resource, further acquire market trend information, competitor information, and seasonality information from an external information resource, and cause the preprocessed data to be mapped to a common time axis and a common classification scheme so as to construct an integrated data set.

### Supplementary 3

The system according to supplementary 1,
wherein the processor is configured to input to the generative AI model, in addition to the prompt sentence for generating a strategy proposal based on an initial prompt sentence, a follow-up prompt sentence received from the user and a prompt sentence including identification information of a past analysis result, iteratively generate a plurality of strategy proposals and respective predicted indicator changes with reuse of the integrated data set, and change a target user segment, a target object group, and measure conditions for each of the plurality of strategy proposals.

### Example 2

### Supplementary 1

A system comprising a processor,
wherein the processor is configured to
receive, from a user terminal, analysis target information, and
receive, from the user terminal, a prompt sentence including an analysis objective expressed in natural language, and
determine a format of the analysis target information and perform preprocessing including at least completion of missing values, exclusion of abnormal values, normalization of formats, and derivation of attributes to generate an analysis dataset, and
generate summary information from the analysis dataset based on contents of the prompt sentence, the summary information including at least one of time series aggregation, category-wise aggregation, statistical value calculation, classification processing, and
clustering processing, and construct input information for a generative AI model, the input information including the summary information and the prompt sentence, and
execute the generative AI model using the input information to generate analysis result text in natural language responding to the summary information and the prompt sentence, and generate visual information based on the analysis dataset and the analysis result text, the visual information including at least one of time-series visualization, category-wise comparison visualization, and distribution visualization, and maintain an association between the visual information and the analysis result text, and
generate response information including the analysis result text and the visual information as constituent information, and transmit the response information to the user terminal, and
receive an additional prompt sentence from the user terminal, reconstruct the input information for the generative AI model while reusing the analysis dataset, and update and iteratively provide the analysis result text and the visual information.

### Supplementary 2

The system according to supplementary 1,
wherein the processor is configured to
extract an analysis type from the prompt sentence, and, in accordance with the extracted analysis type, dynamically select indices, periods, and classification axes to be included in the summary information, and control contents of the input information to the generative AI model.

### Supplementary 3

The system according to supplementary 1,
wherein the processor is configured to
manage correspondence information between description units in the analysis result text and indices in the summary information, and, based on the correspondence information, associate respective elements of the visual information with the description units and output the visual information in a format that allows presentation of the associations.

### Application Example 2

### Supplementary 1

A system comprising a processor,
wherein the processor is configured to
provide, via a terminal, an information input/output interface for receiving an analysis instruction expressed in natural language from a user,
extract, from a content of the analysis instruction, a type of analysis task, an analysis target period, and an output format, and structure the extracted items as an internal representation, acquire, from an external storage apparatus or a communication network, public information resources, paid information resources, and user-specific information resources, and store the acquired information as tabular information and character-string information while unifying a format thereof,
perform preprocessing on the tabular information by executing, at least, missing-value completion, normalization, data type conversion, combination, and removal of unnecessary information, thereby converting the tabular information into a format suitable for analysis, perform preprocessing on the character-string information by executing, at least, tokenization, normalization, and removal of sensitive information, thereby converting the character-string information into a format suitable for analysis,
execute, on the basis of the structured analysis task and the preprocessed tabular information, statistical processing or machine-learning processing to calculate prediction values, index values, and aggregated values,
execute, on the character-string information, emotion analysis processing or topic extraction processing to calculate emotion index values or topic groups,
generate, on the basis of operation-history information transmitted from the terminal and character-string information input by the user, emotion state information indicating an emotion state of the user by performing emotion-recognition processing, and hold the emotion state information as session information,
generate data summary information by summarizing the analysis task, the preprocessed information, the prediction values, the index values, the aggregated values, the emotion index values, and the topic groups, and by listing the summarized items,
construct, on the basis of the data summary information, the analysis instruction, and the emotion state information, a prompt sentence that instructs a generative artificial-intelligence model regarding contents of analysis and explanation and regarding an output format, and generate prompt data including the prompt sentence,
input the prompt data to the generative artificial-intelligence model and cause the generative artificial-intelligence model to generate a text output including an interpretation of the data summary information, insight, meaning attribution, and explanation relating to strategy formulation,
generate, on the basis of the prediction values, the index values, the aggregated values, and the emotion index values, graphic information and numerical information indicating at least one of temporal change, distribution, and comparison relationships by using data-visualization technology,
generate presentation-control information for adjusting, in accordance with the emotion state information, at least one of a detail level, emphasis portions, and a presentation order of the text output and the graphic information, and
transmit, to the terminal, a message including the text output, the graphic information, the numerical information, and the presentation-control information so that the user is enabled to make a decision based on the information.

### Supplementary 2

The system according to supplementary 1,
wherein the processor is configured to, in constructing the prompt sentence, include a description that instructs the generative artificial-intelligence model to add step-by-step explanations and background explanations when the emotion state information indicates anxiety or confusion, and include a description that instructs the generative artificial-intelligence model to provide opportunity-oriented insight and proactive strategy proposals when the emotion state information indicates excitement or expectation.

### Supplementary 3

The system according to supplementary 1,
wherein the processor is configured to select, in accordance with the type of the analysis task and the emotion state information, a template from among a plurality of prompt-sentence templates, generate the prompt sentence by embedding the data summary information and the analysis instruction into the selected template, and record, as history information, a correspondence between the generated prompt sentence and the text output obtained from the generative artificial-intelligence model.

What is claimed is:

1. A system comprising:
circuitry configured to:
receive, via an input interface, an analysis instruction from a user, the analysis instruction comprising an analysis purpose, a data range, and a prompt sentence in natural language;
acquire, based on the analysis instruction, a plurality of types of data from a plurality of data sources via a packet-switched network, the plurality of types of data comprising public information from external information sources, subscription-based information, and user-provided information;
perform preprocessing on the acquired data by unifying data formats, processing missing values, aligning time-series data, and joining the data based on identification attributes to generate an integrated data set;
construct an analysis prompt comprising the prompt sentence, analysis conditions derived from the analysis instruction, and data summary information generated from the integrated data set, the analysis prompt specifying an output format for a generative neural network model;
transmit the analysis prompt to the generative neural network model and receive an analysis result text in natural language;
extract structured information from the analysis result text comprising summary information, quantitative indicators, and classification-based findings; and
generate graphical information by applying a visualization process to the structured information and the integrated data set, and transmit report information comprising the analysis result text, the structured information, and the graphical information to a client terminal via the packet-switched network.

2. The system according to claim 1, wherein the circuitry is configured to perform the preprocessing by executing, for numerical data within the acquired data, data formatting, missing-value completion, unit standardization, and aggregation computation, and for textual data within the acquired data, morphological analysis, normalization, sentiment classification, and topic classification, to generate the integrated data set comprising both numerical and textual preprocessed components.

3. The system according to claim 2, wherein the circuitry is configured to compute, from the integrated data set, summary statistical values comprising mean, variance, and distribution parameters, representative indicators for each classification category, and temporal trend values along a time axis, and to format the computed values as the data summary information within a token constraint of the generative neural network model.

4. The system according to claim 3, wherein the circuitry is configured to construct the analysis prompt by combining the data summary information, the prompt sentence from the user, and constraint parameters specifying a maximum output length and a required output structure, and to include, within the analysis prompt, instructions directing the generative neural network model to output the analysis result text with demarcated sections corresponding to each analysis viewpoint specified in the analysis instruction.

5. The system according to claim 4, wherein the circuitry is configured to parse the analysis result text by identifying the demarcated sections, extract the quantitative indicators and classification-based findings from each section, and validate that the extracted structured information is consistent with the data summary information by comparing extracted numerical values against the computed summary statistical values.

6. The system according to claim 1, wherein the circuitry is configured to generate the graphical information by selecting, based on the data types present in the structured information, at least one of a temporal change chart, a category-based comparison chart, and a ratio distribution chart, and rendering the selected chart types using the quantitative indicators extracted from the analysis result text and corresponding values from the integrated data set.

7. The system according to claim 6, wherein the circuitry is configured to associate each rendered chart with a corresponding section of the analysis result text such that the report information comprises linked pairs of textual analysis and graphical representation, and to generate interactive display control data enabling the client terminal to render the linked pairs in a unified interface.

8. The system according to claim 7, wherein the circuitry is configured to generate table-format information comprising aggregated values, comparison metrics, and ranked lists derived from the structured information, and to include the table-format information in the report information alongside the graphical information and the analysis result text.

9. The system according to claim 1, wherein the circuitry is configured to divide the analysis result text into a plurality of issue segments in accordance with analysis viewpoints specified in the prompt sentence, extract quantitative indicators and proposed actions for each issue segment, and reconstruct the analysis result text to generate the report information in a structured format comprising issue-by-issue findings with associated quantitative evidence.

10. The system according to claim 9, wherein the circuitry is configured to assign priority scores to each issue segment based on magnitude of the quantitative indicators relative to baseline values stored in a database, and to order the issue segments within the report information according to the priority scores.

11. The system according to claim 1, wherein the circuitry is configured to store the report information and the analysis prompt in a storage medium as historical analysis data, and in response to a subsequent analysis instruction from the user, retrieve relevant historical analysis data and incorporate the retrieved data into a new analysis prompt to enable iterative and continuous analysis.

12. The system according to claim 11, wherein the circuitry is configured to compare the analysis result text of the subsequent analysis with the historical analysis data to identify changes in the quantitative indicators over time, and to generate differential analysis information highlighting the identified changes.

13. The system according to claim 12, wherein the circuitry is configured to construct a trend prompt including the differential analysis information and a sequence of historical quantitative indicators, transmit the trend prompt to the generative neural network model, and receive trend prediction information comprising projected values and confidence intervals for the quantitative indicators.

14. The system according to claim 1, wherein the circuitry is configured to acquire the subscription-based information by transmitting authentication credentials to a paid data service via the packet-switched network, receiving access authorization, and retrieving data records within the data range specified in the analysis instruction.

15. The system according to claim 1, wherein the circuitry is configured to estimate an emotional state of the user based on linguistic features in the prompt sentence, and to adjust a level of technical detail and a presentation style of the analysis result text generated by the generative neural network model based on the estimated emotional state.

16. The system according to claim 1, wherein the circuitry is configured to receive feedback information from the client terminal regarding the report information, and to update the analysis prompt based on the feedback information to refine subsequently generated analysis result text and graphical information.

17. The system according to claim 16, wherein the circuitry is configured to identify, based on accumulated feedback information, prompt components that are correlated with positive user evaluations, and to preferentially include the identified prompt components in subsequently constructed analysis prompts.

18. A system comprising:
circuitry configured to:
receive an analysis instruction from a user comprising an analysis purpose and a prompt sentence;
acquire a plurality of types of data from a plurality of data sources via a packet-switched network;
perform preprocessing on the acquired data to generate an integrated data set;
construct an analysis prompt comprising the prompt sentence and data summary information generated from the integrated data set;
transmit the analysis prompt to a generative neural network model and receive an analysis result text;
extract structured information comprising quantitative indicators from the analysis result text;
generate graphical information by applying a visualization process to the structured information;
estimate an emotional state of the user based on the prompt sentence and adjust a presentation style of the analysis result text based on the estimated emotional state; and
transmit report information comprising the analysis result text, the structured information, and the graphical information to a client terminal via the packet-switched network.

19. The system according to claim 18, wherein the circuitry is configured to store the report information as historical analysis data, and in response to a subsequent analysis instruction, incorporate the historical analysis data into a new analysis prompt to enable iterative analysis.

20. A method performed by circuitry, the method comprising:
receiving an analysis instruction from a user comprising an analysis purpose and a prompt sentence;
acquiring a plurality of types of data from a plurality of data sources via a packet-switched network;
performing preprocessing on the acquired data to generate an integrated data set;
constructing an analysis prompt comprising the prompt sentence and data summary information generated from the integrated data set;
transmitting the analysis prompt to a generative neural network model and receiving an analysis result text;
extracting structured information comprising quantitative indicators from the analysis result text;
generating graphical information by applying a visualization process to the structured information; and
transmitting report information comprising the analysis result text, the structured information, and the graphical information to a client terminal via the packet-switched network.
